(19) United States
(12) Patent Application Publication
(10) Pub. No.: US 2026/0020591 A1
(43) Pub. Date: Jan. 22, 2026

(54) FLAVOR BLENDS COMPRISING BRAZZEIN

(71) Applicant: PERFECT DAY, INC., Berkeley, CA (US)

(72) Inventor: Melanie Jean Goulson, Dayton, MN (US)

(21) Appl. No.: 18/997,485

(22) PCT Filed: Jul. 20, 2023
(86) PCT No.: PCT/US23/70640

§ 371 Date: Jan. 21, 2025

Related U.S. Application Data
(60) Provisional application No. 63/368,964, filed on Jul. 20, 2022.

(51) Int. Cl. A23L 27/30; A23C 9/152; A23C 9/156; A23L 2/60; A23L 27/00

(52) U.S. Cl. CPC A23L 27/31; A23C 9/1526; A23C 9/156; A23L 2/60; A23L 27/33; A23L 27/34; A23L 27/84; A23L 27/86; A23L 27/88

(57) ABSTRACT

Provided are flavor blends comprising brazzein and one or more additional sweetener/flavor agents, and ingestible compositions comprising such flavor blends. and methods for making such flavor blends and ingestible compositions.

### RELATED APPLICATIONS

This application claims priority to U.S. Provisional Patent Application Ser. No. 63/368,964, filed on Jul. 20, 2022, which is incorporated herein by reference, in its entirety.

### FIELD OF THE INVENTION

The present invention relates to flavor blends comprising brazzein, ingestible compositions comprising such flavor blends, and methods for making such flavor blends and ingestible compositions. The present invention also relates to flavor blends and ingestible compositions comprising recombinant brazzein.

### BACKGROUND

Including high-calorie sweeteners (e.g., sucrose, glucose, fructose) in ingestible compositions can adversely affect health, such as, for example, by causing or potentiating type II diabetes, overweight and obesity, coronary heart disease, and cancer. Some health risks may be avoided by replacing high-calorie sweeteners with alternative sweeteners of natural or synthetic origin that have low or zero caloric content and/or a lower glycemic index. Concern over safety of synthetic sweeteners held by many consumers has now focused attention on the use of low-or zero-calorie natural sweeteners.

One such low-calorie natural sweetener is brazzein. Native brazzein is isolated from the fruit of the climbing plant Oubli (Pentadiplandra brazzeana Baillon). Brazzein is a protein-based sweetener that is several hundred times sweeter than sugar. In the fruit of the Oubli plant, brazzein is found in two different forms: pyrE-brazzein (comprising a pyroglutamic acid at the N terminus; SEQ ID NO: 1) and des-pyrE-brazzein (lacking the first pyroglutamic acid at the N terminus; SEQ ID NO: 2). An additional form, Q1-brazzein (SEQ ID NO: 3), has been reported, which is not naturally found in the fruit.

Replacing high-calorie sweeteners with natural low-calorie sweeteners has, however, proven challenging. For one, none of the natural low-calorie sweeteners provides the same sensory profile that is provided by the high-calorie sweeteners that consumers are accustomed to, such as, for example, sucrose, glucose, lactose, and fructose. Rather, natural low-calorie sweeteners provide sensory profiles that may comprise, for example, distinct taste notes alongside sweetness (e.g. bitterness, metallic taste, licorice taste, sweet or other aftertaste, cooling taste, caramel, astringent taste) and different taste note intensities (e.g., lower or higher maximum sweetness intensity, sweetness that diminishes on iterative tasting, modulated richness, low average ranked preference, unpleasant mouthfeel); distinct temporal development of sweetness (e.g., duration to onset of sweetness, duration to reach maximum sweetness intensity, duration of lingering sweet aftertaste, adaptation effects); and/or distinct interactions of sweeteners with each other or with taste notes of other taste-producing agents (e.g., acidulants, electrolytes [e.g., potassium, sodium, and chloride], lipids).

Brazzein, for example, exhibits a higher maximum sweetness intensity, a longer duration to onset of sweetness, a longer duration to reach maximum sweetness intensity, and a longer duration of lingering sweet aftertaste compared to commonly used high-calorie sweeteners (e.g., sucrose, fructose, glucose). Brazzein also carries bitter, licorice-like, and astringent taste notes. These unique sensory profiles of brazzein present challenges in formulating flavor blends and ingestible compositions comprising brazzein that have an appealing taste.

Therefore, there remains a need for flavor blends comprising brazzein that can replicate or closely resemble the sensory profiles of commonly used high-calorie sweeteners (e.g., sucrose, glucose, lactose, and fructose), for ingestible compositions comprising such flavor blends, and for methods for producing such flavor blends and ingestible compositions.

### INCORPORATION BY REFERENCE

All publications, patents, patent applications, sequences, database entries, scientific publications, and other references mentioned herein are incorporated by reference in their entireties to the same extent as if each individual publication, patent, patent application, sequence, database entry, scientific publication, or other reference was specifically and individually indicated to be incorporated by reference. To the extent the material incorporated by reference contradicts or is inconsistent with the present disclosure, the present disclosure, including definitions, will supersede any such material.

BRIEF SUMMARY OF THE INVENTION

In various aspects, provided herein is a flavor blend consisting of brazzein and one or more additional sweetener/flavor agents, wherein the flavor blend has a desired sensory profile.

The flavor blend of paragraph [0009], wherein the brazzein is a native brazzein.

The flavor blend of paragraph [0009], wherein the brazzein is a recombinant brazzein.

The flavor blend of any of paragraphs through [0011], wherein the brazzein has a sequence identity of at least 85% to SEQ ID NO: 1, 2, or 3.

The flavor blend of paragraph or [0012], wherein the recombinant brazzein is produced using a recombinant host cell.

The flavor blend of paragraph [0013], wherein the recombinant host cell is a recombinant bacterial host cell.

The flavor blend of paragraph [0013], wherein the recombinant host cell is a recombinant plant host cell.

The flavor blend of paragraph [0013], wherein the recombinant host cell is a recombinant fungal host cell.

The flavor blend of paragraph [0016], wherein the recombinant fungal host cell is a recombinant yeast.

The flavor blend of paragraph [0016], wherein the recombinant fungal host cell is a recombinant filamentous fungal host cell.

The flavor blend of paragraph [0016], wherein the recombinant fungal host cell is derived from Saccharomyces, Kluyveromyces, Pichia, Tetrahymena, Yarrowia, Hansenula, Blastobotrys, Zygosaccharomyces, Debaryomyces, Aspergillus, Candida, Trichoderma, Fusarium, Chrysosporium, Physcomitrella, or Neurospora.

The flavor blend of any of paragraphs through [0019], wherein the one or more additional sweetener/flavor agents comprise or consist of one or more nutritive sweeteners.

The flavor blend of any of paragraphs through [0019], wherein the one or more additional sweetener/flavor agents comprise or consist of one or more high-potency sweeteners.

The flavor blend of any of paragraphs through [0019], wherein the one or more additional sweetener/flavor agents comprise or consist of one or more sweet-tasting amino acids.

The flavor blend of any of paragraphs through [0019], wherein the one or more additional sweetener/flavor agents comprise one or more bulk sweeteners.

The flavor blend of any of paragraphs through [0019], wherein the one or more additional sweetener/flavor agents consist of one or more bulk sweeteners.

The flavor blend of paragraph or [0024], wherein the one or more bulk sweeteners comprise or consist of allulose.

The flavor blend of paragraph or [0024], wherein the one or more bulk sweeteners comprise or consist of erythritol.

The flavor blend of paragraph or [0024], wherein the one or more bulk sweeteners comprise or consist of tagatose.

The flavor blend of paragraph or [0024], wherein the one or more bulk sweeteners comprise or consist of allulose and erythritol.

The flavor blend of paragraph or [0024], wherein the one or more bulk sweeteners comprise or consist of allulose and tagatose.

The flavor blend of paragraph or [0024], wherein the one or more bulk sweeteners comprise or consist of erythritol and tagatose.

The flavor blend of paragraph or [0024], wherein the one or more bulk sweeteners comprise or consist of allulose, erythritol, and tagatose.

The flavor blend of any of paragraphs through [0019], wherein the one or more additional sweetener/flavor agents comprise or consist of one or more acidulants.

The flavor blend of paragraph [0032], wherein the one or more acidulants comprise or consist of malic acid and/or lactic acid.

The flavor blend of any of paragraphs through [0033], wherein the desired sensory profile is a desired temporal profile for sweetness.

The flavor blend of any of paragraphs through [0033], wherein the desired sensory profile is a sensory profile that is similar or identical to that of a sugar.

The flavor blend of paragraph [0035], wherein the sugar is sucrose, glucose, lactose, or a mixture of one or more thereof.

The flavor blend of paragraph [0036], wherein the sugar is sucrose.

The flavor blend of any of paragraphs through [0037], wherein the desired sensory profile comprises or consists of a similar or identical maximum sweetness intensity, a similar or identical duration to onset of sweetness, a similar or identical duration to reach maximum sweetness intensity, a similar or identical duration of lingering sweet aftertaste, and/or a similar or identical average ranked preference score.

The flavor blend of any of paragraphs through [0038], wherein the desired sensory profile is a sensory profile that is different from the sensory profile of a corresponding flavor blend, wherein the corresponding flavor blend is identical to the flavor blend except that it does not comprise the one or more additional sweetener/flavor agents comprised in the flavor blend, or does not comprise the one or more additional sweetener/flavor agents in an amount as comprised in the flavor blend.

The flavor blend of paragraph [0039], wherein the desired sensory profile comprises or consists of a reduction in duration to onset of sweetness, a reduction in duration of lingering sweet aftertaste, a reduction in duration to reach maximum sweetness intensity, and/or an improvement in average ranked preference score compared to the corresponding flavor blend.

The flavor blend of paragraphs [0040], wherein the reduction in duration to onset of sweetness, reduction in duration of lingering sweet aftertaste, reduction in duration to reach maximum sweetness intensity, and/or improvement in average ranked preference score is at least about 3%.

The flavor blend of any of paragraphs through [0041], wherein the flavor blend comprises between 0.001% and 99.99% by mass of brazzein.

The flavor blend of any of paragraphs through [0042], wherein the flavor blend consists of brazzein at a concentration of between about 0.04% and about 3.1% by mass; and of the one or more additional sweetener/flavor agents at a concentration of between about 96.9% and about 99.96% by mass.

The flavor blend of any of paragraphs through [0043], wherein the flavor blend has a SEV of between about 3.5% and about 12%.

In various aspects, provided herein is an ingestible composition comprising the flavor blend of any of paragraphs through [0044].

The ingestible composition of paragraph comprising the flavor blend in an amount that provides a desired sensory profile.

The ingestible composition of paragraph or [0046], wherein the amount is between 0.001% and 100% by mass.

The ingestible composition of any of paragraphs through [0047], wherein the ingestible composition is a food product.

The ingestible composition of paragraph [0048], wherein the food product is a dairy product or substitute dairy product.

The ingestible composition of paragraph [0048], wherein the food product is a beverage.

The ingestible composition of paragraph [0050], wherein the beverage is a water-based beverage.

The ingestible composition of paragraph [0050], wherein the beverage is a protein beverage.

The ingestible composition of paragraph [0052], wherein the protein beverage comprises between about 1% and about 15% by mass of protein.

The ingestible composition of paragraph [0050], wherein the beverage is a dairy protein beverage.

The ingestible composition of paragraph [0054], wherein the dairy protein beverage comprises a recombinant milk protein.

The ingestible composition of paragraph [0055], wherein the recombinant milk protein is a recombinant α-lactalbumin, recombinant β-lactoglobulin, recombinant lactotransferrin, recombinant lactoferricin, recombinant serum albumin protein, recombinant lactoperoxidase protein, and/or recombinant glycomacropeptide, recombinant β-casein, recombinant y-casein, recombinant κ-casein, recombinant α-S1-casein, and/or recombinant α-S2-casein.

The ingestible composition of paragraph [0048], wherein the food product is a tabletop sweetener.

The ingestible composition of any of paragraphs through comprising between about 15 ppm and about 160 ppm of brazzein, and between about 0.5% and about 4% by mass of one or more bulk sweeteners.

The ingestible composition of any of paragraphs through having a SEV of between about 3.5% and about 12%.

The ingestible composition of any of paragraphs through [0059], wherein the ingestible composition is essentially free of any sweetener/flavor agent other than the brazzein and the one or more additional sweetener/flavor agents comprised in the flavor blend.

The ingestible composition of any of paragraphs through having a reduced calorie content and/or a reduced glycemic index compared to a corresponding ingestible composition that is identical to the ingestible composition and has the same SEV as the ingestible composition except that it does not comprise the flavor blend but a sugar (e.g., sucrose, glucose, lactose).

In various aspects, provided herein is a method for producing a flavor blend of any of

paragraphs through comprising: combining an amount of brazzein with an amount of one or more additional sweetener/flavor agents, wherein the amount of brazzein and the amount of the one or more additional sweetener/flavor agents are chosen to provide the desired sensory profile.

The method of paragraph [0062], wherein the brazzein is a native brazzein.

The method of paragraph [0062], wherein the brazzein is a recombinant brazzein.

The method of any of paragraphs through [0064], wherein the brazzein has a sequence identity of at least 85% to SEQ ID NO: 1, 2, or 3.

The method of paragraph or [0065], wherein the recombinant brazzein is produced using a recombinant host cell.

The method of paragraph [0066], wherein the recombinant host cell is a recombinant bacterial host cell.

The method of paragraph [0066], wherein the recombinant host cell is a recombinant plant host cell.

The method of paragraph [0066], wherein the recombinant host cell is a recombinant fungal host cell.

The method of paragraph [0069], wherein the recombinant fungal host cell is a recombinant yeast.

The method of paragraph [0069], wherein the recombinant fungal host cell is a recombinant filamentous fungal host cell.

The method of paragraph [0069], wherein the recombinant fungal host cell is derived from Saccharomyces, Kluyveromyces, Pichia, Tetrahymena, Yarrowia, Hansenula, Blastobotrys, Zygosaccharomyces, Debaryomyces, Aspergillus, Candida, Trichoderma, Fusarium, Chrysosporium, Physcomitrella, or Neurospora.

The method of any of paragraphs through [0072], wherein the brazzein is purified from a source material to a purity of greater than 80% relative to other components comprised in the source material.

The method of any of paragraphs through [0073], wherein the one or more additional sweetener/flavor agents comprise or consist of one or more nutritive sweeteners.

The method of any of paragraphs |0062| through [0074], wherein the one or more additional sweetener/flavor agents comprise or consist of one or more high-potency sweeteners.

The method of any of paragraphs through [0075], wherein the one or more additional sweetener/flavor agents comprise or consist of one or more sweet-tasting amino acids.

The method of any of paragraphs through [0076], wherein the one or more additional sweetener/flavor agents comprise one or more bulk sweeteners.

The method of any of paragraphs through [0073], wherein the one or more additional sweetener/flavor agents consist of one or more bulk sweeteners.

The method of paragraph or [0078], wherein the one or more bulk sweeteners comprise or consist of allulose.

The method of paragraph or [0078], wherein the one or more bulk sweeteners comprise or consist of erythritol.

The method of paragraph or [0078], wherein the one or more bulk sweeteners comprise or consist of tagatose.

The method of paragraph or [0078], wherein the one or more bulk sweeteners comprise or consist of allulose and erythritol.

The method of paragraph or [0078], wherein the one or more bulk sweeteners comprise or consist of allulose and tagatose.

The method of paragraph or [0078], wherein the one or more bulk sweeteners comprise or consist of erythritol and tagatose.

The method of paragraph or [0078], wherein the one or more bulk sweeteners comprise or consist of allulose, erythritol, and tagatose.

The method of any of paragraph through item 69 and 71 through [0085], wherein the one or more additional sweetener/flavor agents comprise or consist of one or more acidulants.

The method of paragraph [0086], wherein the one or more acidulants comprise or consist of malic acid and/or lactic acid.

The method of any of paragraphs through [0087], wherein the one or more additional sweetener/flavor agents are purified from a source material to a purity of greater than greater than 80% relative to other components comprised in the source material.

The method of any of paragraphs through [0088], wherein the desired sensory profile is a desired temporal profile for sweetness.

The method of any of paragraphs through [0089], wherein the desired sensory profile is a sensory profile that is similar or identical to that of a sugar.

The method of paragraph [0090], wherein the sugar is sucrose, glucose, lactose, or a mixture of one or more thereof.

The method of paragraph [0091], wherein the sugar is sucrose.

The method of any of paragraphs through [0092], wherein the desired sensory profile comprises or consists of a similar or identical maximum sweetness intensity, a similar or identical duration to onset of sweetness, a similar or identical duration to reach maximum sweetness intensity, a similar or identical duration of lingering sweet aftertaste, and/or a similar or identical average ranked preference score.

The method of any of paragraphs through [0093], wherein the desired sensory profile is a sensory profile that is different from the sensory profile of a corresponding flavor blend, wherein the corresponding flavor blend is identical to the flavor blend except that it does not comprise the one or more additional sweetener/flavor agents comprised in the flavor blend, or does not comprise the one or more additional sweetener/flavor agents in an amount as comprised in the flavor blend.

The method of paragraph [0094], wherein the desired sensory profile comprises or consists of a reduction in duration to onset of sweetness, a reduction in duration of lingering sweet aftertaste, a reduction in duration to reach maximum sweetness intensity, and/or an improvement in average ranked preference score compared to the corresponding flavor blend.

The method of paragraph [0095], wherein the reduction in duration to onset of sweetness, reduction in duration of lingering sweet aftertaste, reduction in duration to reach maximum sweetness intensity, and/or improvement in average ranked preference score is at least about 3%.

The method of any of paragraphs through [0096], wherein the amount of brazzein is between 0.001% and 99.99% by mass.

The method of any of paragraphs through [0096], wherein the amount of brazzein and the amount of the one or more additional sweetener/flavor agents are chose to provide a SEV of between about 3.5% and about 12%.

The method of any of paragraphs through [0096], wherein the amount of brazzein is between about 0.04% and about 3.1% by mass and the amount of the one or more additional sweetener/flavor agents is between about 96.9% and about 99.96% by mass.

In various aspects, provided herein is a method for conferring a desired sensory profile on an ingestible composition, wherein the method comprises: preparing the ingestible

composition using an amount of the flavor blend of paragraphs through [0044], and/or

adding to the ingestible composition an amount of the flavor blend of paragraphs through [0044].

The method of paragraph [0100], wherein the amount of the flavor blend is chosen to provide a SEV of between about 3.5% and about 12%.

The method of paragraph or [0101], wherein the amount of the flavor blend is chosen to provide a desired sensory profile.

The method of any of paragraphs through [0102], wherein the amount of the flavor blend is between 0.001% and 100% by mass of the ingestible composition.

The method of any of paragraphs through [0103], wherein the one or more additional sweetener/flavor agents comprise or consist of one or more bulk sweeteners.

The method of any of paragraphs through [0104], wherein the amount of the flavor blend is chosen to provide for a final concentration in the ingestible composition of between about 15 ppm and about 160 ppm of the brazzein comprised in the flavor blend, and between about 0.5% and about 4% by mass of the one or more bulk sweeteners comprised in the flavor blend.

The method of any of paragraphs through [0105], wherein the ingestible composition is a food product.

The method of paragraph [0106], wherein the food product is a dairy product or substitute dairy product.

The method of paragraph [0106], wherein the food product is a beverage.

The method of paragraph [0108], wherein the beverage is a water-based beverage. The method of paragraph [0108], wherein the beverage is a protein beverage.

The method of paragraph [0110], wherein the protein beverage comprises between about 1% and about 15% by mass of protein.

The method of paragraph [0106], wherein the beverage is a dairy protein beverage.

The method of paragraph [0112], wherein the dairy protein beverage comprises a recombinant milk protein.

The method of paragraph [0113], wherein the recombinant milk protein is recombinant α-lactalbumin, recombinant β-lactoglobulin, recombinant lactotransferrin, recombinant lactoferricin, recombinant serum albumin protein, recombinant lactoperoxidase protein, and/or recombinant glycomacropeptide, recombinant β-casein, recombinant y-casein, recombinant κ-casein, recombinant α-S1-casein, and/or recombinant α-S2-casein.

The method of paragraph [0106], wherein the food product is a tabletop sweetener.

The method of any of paragraphs through [0115], wherein the ingestible composition is essentially free of any sweetener/flavor agent other than the brazzein and the one or more additional sweetener/flavor agents comprised in the flavor blend.

The method of any of paragraphs through [0116], wherein the ingestible composition a reduced calorie content and/or a reduced glycemic index compared to a corresponding ingestible composition that is identical to the ingestible composition and has the same SEV as the ingestible composition except that it does not comprise the flavor blend but a sugar (e.g., sucrose, glucose, lactose).

### BRIEF DESCRIPTION OF THE FIGURES

FIG. 1 is a concentration response curve of the sucrose equivalent (SE) sweetness of 2 batches of recombinant brazzein as determined by an expert sensory panel. (Error bars represent 1 standard deviation.)

FIG. 2 is a bar chart that compares the duration to onset of sweetness (Onset) and duration to reach maximum sweetness intensity (Rmax) of sucrose and recombinant brazzein at 6% SE sweetness.

FIG. 3 is a spider plot that compares the flavor profile of sucrose and recombinant brazzein at 6% SE sweetness.

FIG. 4 is a bar chart that compares the flavor profile of sucrose and recombinant brazzein at a 6% SE sweetness.

FIG. 5 is a graph plot tracing pH drop during fermentation of brazzein sweetened and unsweetened milk cultures.

### DETAILED DESCRIPTION OF THE INVENTION

The terminology and description used herein are for the purpose of describing particular embodiments only, and are not intended to limit the scope of the invention. Unless defined otherwise, all technical and scientific terms used herein have the same meaning as is commonly understood by one of ordinary skill in the art to which this disclosure pertains. Further, unless otherwise required by context, singular terms shall include the plural, and plural terms shall include the singular.

### Definitions

The terms “a” and “an” and “the” and similar references as used herein refer to both the singular and the plural (e.g., meaning “at least one” or “one or more”), unless otherwise indicated herein or clearly contradicted by context. For example, the term “a compound” is synonymous with the terms “at least one compound” and “one or more compounds”, and may refer to a single compound or to a plurality of compounds, including mixtures thereof.

The term “and/or” as used herein refers to multiple components in combination with or exclusive of one another. For example, “x, y, and/or z” may refer to “x” alone, “y” alone, “z” alone, “x, y, and z”, “(x and y) or z”, “(x and z) or y”, “(y and z) or x”, “x and y” alone, “x and z” alone, “y and z” alone, or “x or y or z”.

The term “average ranked preference score” as used herein refers to the numerical value obtained by calculating the average ranking assigned to a sample by a panel of human sensory experts in comparison to another sample. The lower the average ranked preference score, the more preferred or liked the sample is considered by the panel. The average ranked preference score may be measured as described in Example 5.

The term “at least one” or “one or more” as used herein refers to one, two, three, four, five, six, seven, eight, nine, ten, at least one, at least two, at least three, at least four, at least five, at least six, at least seven, at least eight, at least nine, at least ten, or more, or all of the elements subsequently listed.

The term “beverage” as used herein refers to a liquid intended for human consumption that is typically consumed through drinking.

The term “casein” as used herein refers to a polypeptide that comprises a sequence of at least 20 (e.g., at least 20, at least 30, at least 40, at least 50, at least 60, at least 70, at least 80, at least 90, at least 100, at least 150) amino acids that is at least 40% (e.g., at least 40%, at least 45%, at least 50%, at least 55%, at least 60%, at least 65%, at least 70%, at least 75%, at least 80%, at least 85%, at least 90%, at least 95%, at least 99%, 100%) identical to a sequence of amino acids in a casein natively found in a mammal-produced milk (i.e., a casein that is native to a mammal-produced milk; e.g., a native casein). Non-limiting examples of caseins include β-casein, γ-casein, κ-casein, α-S1-casein, and α-S2-casein. Accordingly, the terms “β-casein”, “γ-casein”, “κ-casein”, “α-S1-casein”, and “α-S2-casein” as used herein refer to a polypeptide that comprises a sequence of at least 20 (e.g., at least 20, at least 30, at least 40, at least 50, at least 60, at least 70, at least 80, at least 90, at least 100, at least 150) amino acids that is at least 40% (e.g., at least 40%, at least 45%, at least 50%, at least 55%, at least 60%, at least 65%, at least 70%, at least 75%, at least 80%, at least 85%, at least 90%, at least 95%, at least 99%, 100%) identical to a sequence of amino acids in a β-casein, γ-casein, κ-casein, α-S1-casein, and α-S2-casein, respectively, natively found in a mammal-produced milk (e.g., native β-casein (e.g., amino acids 16 to 224 of UniProt sequence P02666; amino acids 16 to 222 of UniProt sequence P11839 or P33048; amino acids 16 to 226 of P05814), native γ-casein, native κ-casein (e.g., amino acids 22 to 190 of UniProt sequence P02668; amino acids 22 to 192 of UniProt sequence P02669 or P02670; amino acids 21 to 182 of UniProt sequence P07498), native α-S1-casein (e.g., amino acids 16 to 214 of UniProt sequence P02662, P04653, or P18626; amino acids 16 to 185 of UniProt sequence P47710), and native α-S2-casein (e.g., amino acids 16 to 222 of UniProt sequence P02663; amino acids 16 to 223 of UniProt sequence P04654 or P33049, respectively).

The term “duration of lingering sweet aftertaste” as used herein refers to the duration of time during which a recognizable residual sweet taste on the tongue is perceived after a sample is removed from the mouth. The duration of lingering sweet aftertaste may be measured as described in Example 5.

The term “duration to onset of sweetness” as used herein refers to the duration of time required for perceiving a first recognizable sweet taste on the tongue after taking a sample into the mouth. The duration to onset of sweetness may be measured as described in Example 5.

The term “duration to reach maximum sweetness intensity” as used herein refers to the duration of time required for a perceived sweet taste to reach its peak intensity after taking a sample into the mouth. The duration to reach maximum sweetness intensity may be measured as described in Example 5.

The term “filamentous fungus” as used herein refers to an organism from the filamentous form of the subdivision Eumycota and Oomycota (as defined by Hawksworth et al., In, Ainsworth and Bisby's Dictionary of The Fungi, 8th edition, 1995, CAB International, University Press, Cambridge, UK). A filamentous fungus is distinguished from a yeast by its hyphal elongation during vegetative growth.

The term “flavor blend” as used herein refers to a composition that can impart flavor on a composition.

The term “food product” as used herein refers to a composition that can be ingested by a human or an animal for dietary purposes (e.g., without ill health effects), including a domesticated animal (e.g., dog, cat), farm animal (e.g., cow, pig, horse), and wild animal (e.g., non-domesticated predatory animal). The term includes compositions that may be combined with or added to one or more other ingredients to make a food product that can be ingested by a human or an animal.

The term “fungus” as used herein refers to organisms of the phyla Ascomycotas, Basidiomycota, Zygomycota, and Chythridiomycota, Oomycota, and Glomeromycota. It is understood, however, that fungal taxonomy is continually evolving, and therefore this specific definition of the fungal kingdom may be adjusted in the future.

The term “host cell” as used herein refers not only to the particular subject cell but also to the progeny of such cell. Because certain modifications may occur in succeeding generations due to either mutation or environmental influences, such progeny may not, in fact, be identical to the subject cell, but are still included within the scope of the term “host cell” as used herein.

The terms' “identity” or “identical” in the context of two or more polynucleotide or polypeptide sequences as used herein refer to the nucleotide or amino acid residues that are the same when the two or more polynucleotide or polypeptide sequences, respectively, are aligned for maximum correspondence. Depending on the application, the “identity” can exist over a region of the sequences being compared (e.g., over the length of a functional domain) or over the full length of the sequences. A “region” is considered to be a continuous stretch of at least 9, 14, 19, 24, 29, 34, 39, or more nucleotides, or of at least 6, 10, 14, 18, 22, 26, 30, or more amino acids. For comparison, typically one sequence acts as a reference sequence to which one or more test sequences are compared. When using a sequence comparison algorithm, test and reference sequences are input into a computer, subsequence coordinates are designated, if necessary, and sequence algorithm program parameters are designated. The sequence comparison algorithm then calculates the percent sequence identity for the test sequence(s) relative to the reference sequence, based on the designated program parameters. Optimal alignment of sequences for comparison can be conducted, e.g., by the local homology algorithm of Smith & Waterman, Adv. Appl. Math. 2:482 (1981), by the homology alignment algorithm of Needleman & Wunsch, J. Mol. Biol. 48:443 (1970), by the search for similarity method of Pearson & Lipman, Proc. Nat'l. Acad. Sci. USA 85:2444 (1988), by computerized implementations of these algorithms (GAP, BESTFIT, FASTA, and TFASTA in the Sequence Analysis Software Package of the Genetics Computer Group (GCG), University of Wisconsin Biotechnology Center, which can be used with default parameters), or by visual inspection (see generally Ausubel et al., infra). One example of an algorithm that is suitable for determining percent sequence identity and sequence similarity is the BLAST algorithm (see, for example, Altschul et al. (1990) J. Mol. Biol. 215:403-410; Gish & States. (1993) Nature Genet. 3:266-272; Madden et al. (1996) Meth. Enzymol. 266:131-141; Altschul et al. (1997) Nucleic Acids Res. 25:3389-3402; Zhang 7 Madden. (1997) Genome Res. 7:649-656). Software for performing BLAST analyses is publicly available through the National Center for Biotechnology Information. In cases where two or more polypeptide sequences differ from each other by conservative substitutions, the percent sequence identity or degree of homology can be adjusted upwards to correct for the conservative nature of the substitution. The means for making this adjustment are well known to those skilled in the art. See, e.g., Pearson, 1994, Methods Mol. Biol. 24:307-31 and 25:365-89.

The terms “including,” “includes,” “having,” “has,” “with,” or variants thereof as used herein are intended to be inclusive in a manner similar to the term “comprising”.

The term “ingestible composition” as used herein refers to a composition that can be ingested by a human or animal. Non-limiting examples of ingestible compositions include food products, pharmaceuticals, dietary supplements, functional foods, beverages, and consumer products (e.g., oral dentifrices).

The term “microbe” or “microbial cell” as used herein is an abbreviation for microorganism, and includes all bacteria, archaea, unicellular protista, unicellular animals, unicellular plants, fungi (e.g., unicellular fungi, filamentous fungi, yeast), unicellular algae, protozoa, and chromista. The term “microbial” is used herein as the corresponding adjective. The term “milk protein” as used herein refers to a whey protein or a casein.

The term “mouthfeel” as used herein refers to the overall appeal of a food product that is independent of taste, which stems from the combination of several characteristics that together provide a satisfactory oral sensory experience. The mouthfeel of a food product can be determined using a panel of human sensory experts. Non-limiting examples of attributes that determine mouthfeel include creaminess, richness, body, complexity, body-richness, thickness, sliminess, and stringiness.

The term “native” as used herein refers to what is found in nature in its unmodified state (e.g., a cell that is not genetically modified by a human, and that is maintained under conditions [e.g., level of oxygenation, pH, salt concentration, temperature, and nutrient (e.g., carbon, nitrogen, sulfur) availability] that are not defined by a human).

The term “polynucleotide” as used herein refers to a polymeric form of at least 2 (e.g., at least 5, at least 10, at least 20, at least 30, at least 40, at least 50, at least 100, at least 500, at least 1,000) nucleotides. The term includes both sense and antisense strands of DNA molecules (e.g., cDNA, genomic DNA, synthetic DNA) and RNA molecules (e.g., mRNA, synthetic RNA), as well as analogs of DNA or RNA containing non-natural nucleotide analogs, non-native internucleoside bonds, and/or chemical modifications. A polynucleotide may be modified chemically or biochemically, or it may contain non-natural or derivatized nucleotide bases. Such modifications include, for example, labels; methylation; substitution of one or more of the naturally occurring nucleotides with an analog; internucleotide modifications such as uncharged linkages (e.g., methyl phosphonates, phosphotriesters, phosphoramidates, carbamates), charged linkages (e.g., phosphorothioates, phosphorodithioates), pendent moieties (e.g., polypeptides), intercalators (e.g., acridine, psoralen), chelators, alkylators, and modified linkages (e.g., alpha anomeric nucleic acids). Examples of modified nucleotides are described in the art (see, for example, Malyshev et al. 2014. Nature 509:385; Li et al. 2014. J. Am. Chem. Soc. 136:826). Also included are synthetic molecules that mimic polynucleotides in their ability to bind to a designated sequence via hydrogen bonding or other chemical interactions. Such molecules are known in the art and include, for example, molecules in which peptide linkages substitute for phosphate linkages in the backbone of the molecule. Other modifications can include, for example, analogs in which the ribose ring contains a bridging moiety or other structure, such as the modifications found in “locked” polynucleotides. A polynucleotide can be in any topological conformation. For instance, a polynucleotide can be single-stranded, double-stranded, triple-stranded, quadruplexed, partially double-stranded, branched, hairpinned, circular, or in a padlocked conformation. The term “polynucleotide sequence” as used herein refers to a sequence of nucleotides that are comprised in a polynucleotide or of which a polynucleotide consists.

The terms “polypeptide” and “protein” as used herein can be interchanged and refer to both a naturally occurring and a non-naturally occurring polymeric form of at least 2 (e.g., at least 5, at least 10, at least 20, at least 30, at least 40, at least 50, at least 100) amino acids, having an active structure or lacking a functional structure. The term “protein” as used herein refers to a polypeptide of any length, which can include polypeptides comprising coded and non-coded amino acids, polypeptides comprising amino acids that occur in nature, and those that do not occur in nature, polypeptides comprising chemically or biochemically modified or derivatized amino acids, and polypeptides comprising modified peptide backbones. A protein can be monomeric, meaning it has a single chain, or polymeric, meaning it is composed of two or more chains, which can be covalently or non-covalently associated.

The term “ppm”, as used herein, means parts per million and is a weight-relative parameter. One part-per-million is equivalent to one microgram per gram. For example, a component that is present in a mixture at 10 ppm is present at 10 micrograms of the component per 1 gram of the mixture.

The term “recombinant brazzein” as used herein refers to a brazzein that is produced by a recombinant host cell, or to a brazzein that is synthesized from a recombinant polynucleotide, and that comprises a sequence of at least 20 (e.g., at least 20, at least 30, at least 40, at least 50, at least 60, at least 70, at least 80, at least 90, at least 100, at least 150) amino acids that is at least 50% (e.g., at least 50%, at least 55%, at least 60%, at least 65%, at least 70%, at least 75%, at least 80%, at least 85%, at least 90%, at least 95%, at least 99%, 100%) identical to a sequence of amino acids in a native brazzein (e.g., SEQ ID NO: 1, 2, or 3).

The term “recombinant host cell” as used herein refers to a host cell that comprises a recombinant polynucleotide. Thus, for example, a recombinant host cell may produce a polynucleotide or polypeptide not found in the native (non-recombinant) form of the host cell, or a recombinant host cell may produce a polynucleotide or polypeptide at a level that is different from that in the native (non-recombinant) form of the host cell. It should be understood that such term is intended to refer not only to the particular subject cell but also to the progeny of such a cell. Because certain modifications may occur in succeeding generations due to either mutation or environmental influences, such progeny may not be identical to the subject cell, but are still included within the scope of the term “recombinant host cell” as used herein. A recombinant host cell may be an isolated cell or cell line grown in culture or a cell that resides in a living tissue or organism.

The term “sensory profile” as used herein refers to sensory characteristics and attributes (e.g., taste, aroma, and chemesthesis sensations produced over time) that can be experienced by a human. Non-limiting examples of such sensory characteristics and attributes include duration to onset of sweetness, duration of lingering sweet aftertaste, duration to reach maximum sweetness intensity, and average ranked preference score.

The term “similar” as used herein refers to being within about +/−15% with regard to a specified attribute. The term includes being within about +/−15%, about +/−14%, about +/−13%, about +/−12%, about +/−11%, about +/−10%, about +/−9%, about +/−8%, about +/−7%, about +/−6%, about +/−5%, about +/−4%, about +/−3%, about +/−2%, or about +/−1% with regard to the specified attribute.

The term “sucrose equivalent value” (SEV) as used herein refers to the relative sweetness of a sweetener in comparison to sucrose (table sugar). Specifically, the SEV is the amount of sucrose that produces the same sweet taste intensity as the amount of the sweetener in the same matrix. SEV is typically quoted as a percentage. For example, a SEV of 10% corresponds to the sweet taste intensity that is provided by a 10% sucrose content in the same matrix. The SEV can be determined through evaluation by a panel of human sensory experts.

The term “sweetener/flavor agent” as used herein refers to a compound that modulates (e.g., enhances, multiplies, potentiates, decreases, suppresses, or induces) a flavor (e.g., by activating taste receptors in the gustatory system, aroma receptors in the olfactory system, and/or chemesthesis receptors (e.g., receptors related to senses such as pain, touch, and thermal perception)).

The term “whey protein” as used herein refers to a polypeptide that comprises a sequence of at least 20 (e.g., at least 20, at least 30, at least 40, at least 50, at least 60, at least 70, at least 80, at least 90, at least 100, at least 150) amino acids that is at least 40% (e.g., at least 40%, at least 45%, at least 50%, at least 55%, at least 60%, at least 65%, at least 70%, at least 75%, at least 80%, at least 85%, at least 90%, at least 95%, at least 99%, 100%) identical to a sequence of amino acids in a whey protein natively found in a mammal-produced milk (i.e., a whey protein that is native to a mammal-produced milk; e.g., a native whey protein). Non-limiting examples of whey proteins include α-lactalbumin, β-lactoglobulin, lactotransferrin, lactoferricin, serum albumin protein, lactoperoxidase protein, and glycomacropeptide. Accordingly, the terms “α-lactalbumin”, “β-lactoglobulin”, “lactotransferrin”, “lactoferricin”, “serum albumin”, “lactoperoxidase”, and “glycomacropeptide” as used herein refer to a polypeptide that comprises a sequence of at least 20 (e.g., at least 20, at least 30, at least 40, at least 50, at least 60, at least 70, at least 80, at least 90, at least 100, at least 150) amino acids that is at least 40% (e.g., at least 40%, at least 45%, at least 50%, at least 55%, at least 60%, at least 65%, at least 70%, at least 75%, at least 80%, at least 85%, at least 90%, at least 95%, at least 99%, 100%) identical to a sequence of amino acids in an α-lactalbumin, β-lactoglobulin, lactotransferrin, lactoferricin, serum albumin, lactoperoxidase, and glycomacropeptide (GMP), respectively, natively found in a mammal-produced milk (e.g., native a-lactalbumin protein (e.g., amino acids 20-142 of UniProt sequence P00709, P00711, P00712, or P09462), native ß-lactoglobulin protein (amino acids 17-178 of UniProt sequence P02754, amino acids 19-180 of UniProt sequence P67976 or P02756), native lactotransferrin protein (e.g., amino acids 20 to 708 of UniProt sequence P24627, D3G9G3, or Q29477; amino acids 20 to 710 of UniProt sequence P02788), native lactoferricin (amino acids 36 to 60 of UniProt sequence P24627), native serum albumin protein (e.g., amino acids 25 to 607 of UniProt sequence P02769 or P14639; amino acids 19 to 608 of UniProt sequence A0A452F7Y5; amino acids 25 to 609 of UniProt sequence P02768), native lactoperoxidase protein (amino acids 101 to 712 of UniProt sequence P80025), and native glycomacropeptide (GMP; e.g., amino acids 127 to 190 of UniProt sequence P02668)).

The acronym “w/w” as used herein in reference to proportions by weight, means the ratio of the weight of one substance in a composition to the weight of the composition. For example, reference to a composition that comprises 5% w/w of a substance means that 5% of the composition's weight is composed of the substance (e.g., such a composition having a weight of 100 mg would contain 5 mg of the substance) and the remainder of the weight of the composition (e.g., 95 mg in the example) is composed of other ingredients.

The term “yeast” as used herein refers to any organism of the order Saccharomycesles. Vegetative growth of yeast is by budding/blebbing of a unicellular thallus, and carbon catabolismmay be fermentative.

Recitation of ranges of values herein is merely intended to serve as a shorthand method of referring individually to each separate value (fractional or integral) falling within the range inclusive of the recited minimum and maximum value, unless otherwise indicated herein, and each separate value is incorporated into the specification as if it were individually recited herein. Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of less than or equal to 10. It further should be understood that all ranges and quantities described below are approximations and are not intended to limit the invention.

It further should be understood that in any method disclosed herein the order of steps or order for performing certain actions is immaterial so long as the invention remains operable. Moreover, two or more steps or actions may be conducted simultaneously.

### Flavor Blend Comprising Brazzein

In various aspects, provided herein is a flavor blend consisting of brazzein and one or more additional sweetener/flavor agents, wherein the flavor blend has a desired sensory profile.

The brazzein and/or the one or more additional sweetener/flavor agents may, for example, enhance (e.g., in additive or synergistic manner), reduce (e.g., in subtractive or synergistic manner), or modulate the sweetness or other flavor (e.g., lemon aroma note) of the flavor blend; modify a temporal profile for sweetness or other flavor of the flavor blend; and/or reduce or eliminate an unpleasant taste note (e.g., bitterness, aftertaste) of the flavor blend compared to a flavor blend not comprising the brazzein and/or the one or more additional sweetener/flavor agents.

The brazzein comprised in the flavor blend according to any of the above may be a native brazzein and/or a non-native brazzein (e.g., a brazzein comprising one or more amino acid substitutions, deletions, or additions), and may have a sequence identity of at least 85%, at least 90%, at least 95%, at least 97%, or 100% to SEQ ID NO: 1, 2, or 3. As a further example, the brazzein may be a recombinant brazzein that is produced using a recombinant host cell. The recombinant host cell may be a recombinant fungal host cell. Non-liming examples of host cells from which the recombinant fungal host cells are derived include Saccharomyces, Kluyveromyces, Pichia, Tetrahymena, Yarrowia, Hansenula, Blastobotrys, Zygosaccharomyces, Debaryomyces, Aspergillus (e.g., Aspergillus nidulans, Aspergillus niger, Aspergillus oryzae), Candida (e.g., Candida albicans), Trichoderma (e.g., Trichoderma reesei), Fusarium (e.g., Fusarium graminearum, Fusarium venenatum), Chrysosporium (e.g., Chrysosporium lucknowense), Physcomitrella (e.g., Physcomitrella patens), and Neurospora (e.g., Neurospora crass).

The one or more additional sweetener/flavor agents comprised in the flavor blend according to any of the above may comprise or consist of one or more nutritive sweeteners (i.e., sweeteners that can be metabolized to release energy). Non-limiting examples of nutritive sweeteners include sugars (e.g., glucose/dextrose, sucrose, fructose, lactose, maltose, isomaltose, levulose, galactose, maltulose, isomaltulose, ribose, rutinose, dextrin, cellobiose, nuline, high fructose corn syrup, corn syrup, invert sugar, agave nectar, trehalose, β,β-trehalose, α,β-trehalose, xylose, allulose, tagatose, kojibiose, nigerose, sophorose, laminaribiose, gentiobiose, turanose, gentiobiulose, mannobiose, melibiose, melibiulose, rutinulose, xylobiose, reduced gentio-oligosaccharides, isomalto-oligosaccharides, palatinose, reduced xylo-oligosaccharides, melizitose, raffinose, lactulose, rhamnose, sorbose), sugar alcohols (e.g., erythritol, sorbitol, threitol, arabitol, ribitol, maltitol, mannitol, lactitol, xylitol, inositol, glycerol, propylene glycol, iditol, polyglycitol, dulcitol, threitol, galactitol), vegetable preparations containing predominantly these carbohydrates (e.g. from sugar beet (Beta vulgaris ssp., sugar fractions, sugar syrup, molasses), from sugar cane (Saccharum officinarum ssp., e.g. molasses, sugar syrups), from sugar maple (Acer ssp.), from agave (agave thick juice), synthetic/enzymatic hydrolysates of starch or sucrose (e.g. invert sugar syrup, highly enriched fructose syrups made from corn starch), fruit concentrates (e.g. concentrates from apples or pears, apple syrup, pear syrup), and mixtures of two or more thereof.

The one or more additional sweetener/flavor agents comprised in the flavor blend according to any of the above may comprise or consist of one or more high-potency sweeteners (i.e., sweeteners that are many times sweeter than sucrose on a mass-by-mass basis). Non-limiting examples of high-potency sweeteners include steviol glycosides (e.g., stevioside, rebaudioside A (RebA), rebaudioside B (RebB), rebaudioside C (RebC), rebaudioside D (RebD), rebaudioside E (RebE), rebaudioside F (RebF), dulcoside A, dulcoside B, rubusoside), monatin and its salts (monatin SS, RR, RS, SR), thaumatin, miraculin, monellin, mabinlin, curculin, pentadin, mogrosides (e.g., mogroside I, mogroside II, mogroside III, mogroside IV, mogroside V, mogroside VI, isomogroside, 11-oxomogroside, siamenoside) , glycyrrhyzic acid and its salts, hernandulcin, phyllodulcin, siamenoside, glycyphyllin, phloridzin, trilobatin, baiyunoside, osladin, polypodoside A, pterocaryoside A, pterocaryoside B, mukurozioside, phlomisoside I, periandrin I, abrusoside A, cydocarioside I, glycyrrhizin, glycyrrhizic acid and its salts, Rooibos extract, Honeybush extract, aspartame, sucralose, saccharin and its salts, acesulfame and its salts (e.g., acesulfame-K), alitame, advantame, cyclamic acid and its salts, neotame, lugduname, carrelame, sucrononate, sucrooctate, dihydrochalcones (e.g., neohesperidin dihydrochalcone), and mixtures of two or more thereof.

The one or more additional sweetener/flavor agents comprised in the flavor blend according to any of the above may comprise or consist of one or more sweet-tasting amino acids. Non-limiting examples of sweet-tasting amino acids include glycine, leucine, threonine, asparagine, phenylalanine, tryptophan, proline, and mixtures of two or more thereof.

The one or more additional sweetener/flavor agents comprised in the flavor blend according to any of the above may comprise or consist of one or more bulk sweeteners (i.e., low-calorie or non-calorie sweeteners of natural or artificial origin that can be added in larger quantities to a food product). Non-limiting examples of bulk sweeteners include allulose, erythritol, tagatose, stevia, monk fruit extract (luo han guo), aspartame, sucralose, and mixtures of two or more thereof. Allulose (also known as d-allulose or d-psicose) is a low-calorie monosaccharide sugar that is naturally present in small quantities in certain fruits and foods, such as figs, raisins, and jackfruit. Erythritol is a low-calorie sugar alcohol that occurs naturally in certain fruits and fermented foods. Tagatose is a low-calorie monosaccharide sugar that occurs naturally in small amounts in certain foods, such as, for example, dairy products.

The one or more additional sweetener/flavor agents comprised in the flavor blend according to any of the above may comprise or consist of an acidulant. Non-limiting examples of acidulants include citric acid, malic acid, phosphoric acid, tartaric acid, lactic acid, fumaric acid, alginic acid, ascorbic acid, benzoic acid, adipic acid, and mixtures of two or more thereof.

The desired sensory profile of the flavor blend according to any of the above may be a sensory profile that is similar or identical to that of a sugar (e.g., sucrose, glucose, lactose, or a mixture of one or more thereof). Such similarity or identity may comprise or consist of similar or identical maximum sweetness intensity, similar or identical duration to onset of sweetness, similar or identical duration to reach maximum sweetness intensity, similar or identical duration of lingering sweet aftertaste, and/or similar or identical average ranked preference score. Sensory profiles can be characterized using experienced sensory evaluators. For example, sensory evaluators experienced in sweetness estimation procedures can describe the sensory profile of a test sample in comparison to a reference solution of known sensory profile (e.g., a sucrose solutions; see, for example, Example 5).

The desired sensory profile of the flavor blend according to any of the above may be a sensory profile that is different from the sensory profile of a corresponding flavor blend (i.e., a flavor blend that is identical to the flavor blend that is being compared to the “corresponding flavor blend” except that it does not comprise the one or more additional sweetener/flavor agents comprised in the flavor blend, or does not comprise the one or more additional sweetener/flavor agents in an amount provided herein.

Such difference in sensory profile may comprise or consist of a reduction in duration to onset of sweetness, a reduction in duration of lingering sweet aftertaste, a reduction in duration to reach maximum sweetness intensity, and/or an improvement in average ranked preference score. For example, such reduction in duration to onset of sweetness, reduction in duration of lingering sweet aftertaste, reduction in duration to reach maximum sweetness intensity, and/or improvement in average ranked preference score may by at least about 3%, at least about 5%, at least about 10%, at least about 15%, at least about 20%, at least about 25%, at least about 30% at least about 35%, at least about 40%, or more.

The flavor blend according to any of the above may comprise between 0.001% and 99.99%, 95%, 90%, 80%, 70%, 60%, 50%, 40%, 30%, 20%, or 10%; between 0.0001% and 99.99%, 90%, 80%, 70%, 60%, 50%, 40%, 30%, 20%, or 10%; between 10% and 99.99%, 90%, 80%, 70%, 60%, 50%, 40%, 30%, or 20%; between 20% and 99.99%, 90%, 80%, 70%, 60%, 50%, 40%, or 30%; between 30% and 99.99%, 90%, 80%, 70%, 60%, 50%, or 40%; between 40% and 99.99%, 90%, 80%, 70%, 60%, or 50%; between 50% and 99.99%, 90%, 80%, 70%, or 60%; between 60% and 99.99%, 90%, 80%, or 70%; between 70% and 99.99%, 90%, or 80%; between 80% and 99.99%, or 90%; or between 90% and 99.99% by mass of brazzein.

The flavor blend according to any of the above may consist of brazzein at a concentration of between about 0.04% and about 3.1% by mass (e.g., between about 0.04% and about 3.1%, about 2.8%, about 2.5%, about 2.2%, about 1.9%, about 1.6%, about 1.3%, about 1.0%, about 0.7%, about 0.4%, about 0.1%, or about 0.08%; between about 0.08% and about 3.1%, about 2.8%, about 2.5%, about 2.2%, about 1.9%, about 1.6%, about 1.3%, about 1.0%, about 0.7%, about 0.4%, or about 0.1%; between about 0.1% and about 3.1%, about 2.8%, about 2.5%, about 2.2%, about 1.9%, about 1.6%, about 1.3%, about 1.0%, about 0.7%, or about 0.4%; between about 0.4% and about 3.1%, about 2.8%, about 2.5%, about 2.2%, about 1.9%, about 1.6%, about 1.3%, about 1.0%, or about 0.7%; between about 0.7% and about 3.1%, about 2.8%, about 2.5%, about 2.2%, about 1.9%, about 1.6%, about 1.3%, or about 1.0%; between about 1.0% and about 3.1%, about 2.8%, about 2.5%, about 2.2%, about 1.9%, about 1.6%, or about 1.3%; between about 1.3% and about 3.1%, about 2.8%, about 2.5%, about 2.2%, about 1.9%, or about 1.6%; between about 1.6% and about 3.1%, about 2.8%, about 2.5%, about 2.2%, or about 1.9%; between about 1.9% and about 3.1%, about 2.8%, about 2.5%, or about 2.2%; between about 2.2% and about 3.1%, about 2.8%, or about 2.5%; between about 2.5% and about 3.1%, or about 2.8%; or between about 2.8% and about 3.1% by mass), and of the one or more additional sweetener/flavor agents at a concentration of between about 96.90% and about 99.96%, by mass. The flavor blend may have a SEV of between about 3.5% and about 12% (e.g., between about 3.5% and about 12%, about 11.5%, about 11%, about 10.5%, about 10%, about 9.5%, about 9%, about 8.5%, about 8%, about 7.5%, about 7%, about 6.5%, about 6%, about 5.5%, about 5%, about 4.5%, or about 4%; between about 4% and about 12%, about 11.5%, about 11%, about 10.5%, about 10%, about 9.5%, about 9%, about 8.5%, about 8%, about 7.5%, about 7%, about 6.5%, about 6%, about 5.5%, about 5%, or about 4.5%; between about 4.5% and about 12%, about 11.5%, about 11%, about 10.5%, about 10%, about 9.5%, about 9%, about 8.5%, about 8%, about 7.5%, about 7%, about 6.5%, about 6%, about 5.5%, or about 5%; between about 5% and about 12%, about 11.5%, about 11%, about 10.5%, about 10%, about 9.5%, about 9%, about 8.5%, about 8%, about 7.5%, about 7%, about 6.5%, about 6%, or about 5.5%; between about 5.5% and about 12%, about 11.5%, about 11%, about 10.5%, about 10%, about 9.5%, about 9%, about 8.5%, about 8%, about 7.5%, about 7%, about 6.5%, or about 6%; between about 6% and about 12%, about 11.5%, about 11%, about 10.5%, about 10%, about 9.5%, about 9%, about 8.5%, about 8%, about 7.5%, about 7%, or about 6.5%; between about 6.5% and about 12%, about 11.5%, about 11%, about 10.5%, about 10%, about 9.5%, about 9%, about 8.5%, about 8%, about 7.5%, or about 7%; between about 7% and about 12%, about 11.5%, about 11%, about 10.5%, about 10%, about 9.5%, about 9%, about 8.5%, about 8%, or about 7.5%; between about 7.5% and about 12%, about 11.5%, about 11%, about 10.5%, about 10%, about 9.5%, about 9%, about 8.5%, or about 8%; between about 8% and about 12%, about 11.5%, about 11%, about 10.5%, about 10%, about 9.5%, about 9%, or about 8.5%; between about 8.5% and about 12%, about 11.5%, about 11%, about 10.5%, about 10%, about 9.5%, or about 9%; between about 9% and about 12%, about 11.5%, about 11%, about 10.5%, about 10%, or about 9.5%; between about 9.5% and about 12%, about 11.5%, about 11%, about 10.5%, or about 10%; between about 10% and about 12%, about 11.5%, about 11%, or about 10.5%; between about 10.5% and about 12%, about 11.5%, or about 11%; between about 11% and about 12%, or about 11.5%; or between about 11.5% and about 12%).

The flavor blend according to any of the above may have any form. Non-limiting examples of suitable forms include powder, granule, capsule, suspension, emulsion, microemulsion, nanoemulsion, syrup, liquid, stick, tablet, cube, tabletop sweetener, batch pack, and aerosol.

The flavor blend according to any of the above may be conveniently packaged in a single serving size, which can be measured in units such as grams, teaspoons, tablespoons, tablets, cubes, drops, cups, pounds, kilograms, or their corresponding standardized equivalent measures.

The flavor blend according to any of the above may be low-calorie (e.g., have less than 40 calories per 8 oz serving) or zero-calorie (e.g., have less than 5 calories per 8 oz serving).

### Ingestible Composition Comprising Flavor Blend

In various aspects, provided herein is an ingestible composition that comprises a flavor blend according to any of the above.

The ingestible composition may comprise the flavor blend in an amount that provides a desired sensory profile. For example, the ingestible composition may comprise between 0.001% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, or 0.1%; between 0.1% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, 2%, 1%, 0.9%, 0.8%, 0.7%, 0.6%, 0.5%, 0.4%, 0.3%, or 0.2%; between 0.2% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, 2%, 1%, 0.9%, 0.8%, 0.7%, 0.6%, 0.5%, 0.4%, or 0.3%; between 0.3% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, 2%, 1%, 0.9%, 0.8%, 0.7%, 0.6%, 0.5%, or 0.4%; between 0.4% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, 2%, 1%, 0.9%, 0.8%, 0.7%, 0.6%, or 0.5%; between 0.5% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, 2%, 1%, 0.9%, 0.8%, 0.7%, or 0.6%; between 0.6% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, 2%, 1%, 0.9%, 0.8%, or 0.7%; between 0.7% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, 2%, 1%, 0.9%, or 0.8%; between 0.8% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, 2%, 1%, or 0.9%; between 0.9% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, 2%, or 1%; between 1% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, 5%, 4%, 3%, or 2%; between 2% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, 5%, 4%, or 3%; between 3% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, 5%, or 4%; between 4% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, 6%, or 5%; between 5% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, 7%, or 6%; between 6% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, 8%, or 7%; between 7% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, 9%, or 8%; between 8% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, 10%, or 9%; between 9% and 100%, 95%, 90%, 85%, 80%, 75%, 70%, 65%, 60%, 55%, 50%, 45%, 40%, 35%, 30%, 25%, 20%, 15%, 14%, 13%, 12%, 11%, or 10%; between 10% and 100%, 95%, 90%, 85%, 80%, 75%, 70%, 65%, 60%, 55%, 50%, 45%, 40%, 35%, 30%, 25%, 20%, 15%, 14%, 13%, 12%, or 11%; between 11% and 100%, 95%, 90%, 85%, 80%, 75%, 70%, 65%, 60%, 55%, 50%, 45%, 40%, 35%, 30%, 25%, 20%, 15%, 14%, 13%, or 12%; between 12% and 100%, 95%, 90%, 85%, 80%, 75%, 70%, 65%, 60%, 55%, 50%, 45%, 40%, 35%, 30%, 25%, 20%, 15%, 14%, or 13%; between 13% and 100%, 95%, 90%, 85%, 80%, 75%, 70%, 65%, 60%, 55%, 50%, 45%, 40%, 35%, 30%, 25%, 20%, 15%, or 14%; between 14% and 100%, 95%, 90%, 85%, 80%, 75%, 70%, 65%, 60%, 55%, 50%, 45%, 40%, 35%, 30%, 25%, 20%, or 15%; between 15% and 100%, 95%, 90%, 85%, 80%, 75%, 70%, 65%, 60%, 55%, 50%, 45%, 40%, 35%, 30%, 25%, or 20%; between 20% and 100%, 95%, 90%, 85%, 80%, 75%, 70%, 65%, 60%, 55%, 50%, 45%, 40%, 35%, 30%, or 25%; between 25% and 100%, 95%, 90%, 85%, 80%, 75%, 70%, 65%, 60%, 55%, 50%, 45%, 40%, 35%, or 30%; between 30% and 100%, 95%, 90%, 85%, 80%, 75%, 70%, 65%, 60%, 55%, 50%, 45%, 40%, or 35%; between 35% and 100%, 95%, 90%, 85%, 80%, 75%, 70%, 65%, 60%, 55%, 50%, 45%, or 40%; between 40% and 100%, 95%, 90%, 85%, 80%, 75%, 70%, 65%, 60%, 55%, 50%, or 45%; between 45% and 100%, 95%, 90%, 85%, 80%, 75%, 70%, 65%, 60%, 55%, or 50%; between 50% and 100%, 95%, 90%, 85%, 80%, 75%, 70%, 65%, 60%, or 55%; between 55% and 100%, 95%, 90%, 85%, 80%, 75%, 70%, 65%, or 60%; between 60% and 100%, 95%, 90%, 85%, 80%, 75%, 70%, or 65%; between 65% and 100%, 95%, 90%, 85%, 80%, 75%, or 70%; between 70% and 100%, 95%, 90%, 85%, 80%, or 75%; between 75% and 100%, 95%, 90%, 85%, or 80%; between 80% and 100%, 95%, 90%, or 85%; or between 85% and 100%, 95%, 90%; between 90% and 100% or 95%, or between 95% and 100% by mass of the flavor blend.

At standard ambient temperature and conditions (i.e., 20-30° C. and 0.95-1.05 atm), the ingestible composition according to any of the above may be a fluid, semi-solid (e.g., gelatinous), solid, or powder. The powder may comprise a moisture content of less than 20%, less than 15%, less than 10%, less than 7%, less than 5%, less than 3%, or less than 1%; or between 0.1% and 20%, 15%, 10%, 5%, or 1%; between 1% and 20%, 15%, 10%, or 5%; between 5% and 20%, 15%, or 10%; between 10% and 20%, or 15%; or between 15% and 20%. The powder may be used in powder form, or the powder may be reconstituted with a hydrating agent prior to use, or the powder may be mixed with other dry components (e.g., flour, sugar, minerals, pH or ionic strength adjusting agents) before a hydrating agent is added to the mixture. Non-limiting examples of suitable hydrating agents include water, milk (e.g., animal milk, nut milk, plant-based milk), juice (e.g., vegetable juice, fruit juice, other plant juice), brine (e.g., fluid or liquid used to soak beans or legumes), and mixtures thereof.

The ingestible compositions according to the above may be a food product. The food product may be selected from any of the food product categories defined by the National Health and Nutrition Examination Survey (NHANES). Non-limiting examples of NHANES food product categories include; beverages (e.g., beers and ales, beverage concentrates, beverages, energy drinks, sports drinks, fluid replacements, soft drinks, beverage powders and liquid beverage concentrates, flavored waters, carbonated beverages, juices, wines, beers, cocktails, nutrition drinks, nutrition powders, protein-enriched beverages, coffee, tea); sweets and desserts (e.g., cakes, candies [e.g., chewy candy, crunch candy, low boiled candy, hard-boiled candy], fillings, fondants, nougats, caramels, chocolate, confectionery coatings and drops, chewing gum,, ices or popsicles,, sugar replacements or substitutes, syrups, honey, jellies, jams, preserves, salads, crepes,

The ingestible compositions according to any of the above may be a dairy product, or may resemble a dairy product (i.e., may be a “substitute dairy product”). The term “dairy product” as used herein refers to milk (e.g., whole milk [at least 3.25% milk fat], partly skimmed milk [from 1% to 2% milk fat], skim milk [less than 0.2% milk fat], flavored milk [e.g., chocolate milk, vanilla milk, strawberry milk], whipped cream, cooking milk, condensed milk, flavored milk, goat milk, sheep milk, dried milk, evaporated milk, milk foam), and products derived from milk, including but not limited to yogurt (e.g., whole milk yogurt [at least 6 grams of fat per 170 g], low-fat yogurt [between 2 and 5 grams of fat per 170 g], nonfat yogurt [0.5 grams or less of fat per 170 g], greek yogurt [strained yogurt with whey removed], whipped yogurt, goat milk yogurt, Labneh [labne], sheep milk yogurt, yogurt drinks [e.g., whole milk Kefir, low-fat milk Kefir], Lassi), cheese (e.g., whey cheese such as ricotta; pasta filata cheese such as mozzarella; semi-soft cheese such as Havarti and Muenster; medium-hard cheese such as Swiss and Jarlsberg and halloumi; hard cheese such as Cheddar and Parmesan; washed curd cheese such as Colby and Monterey Jack; soft ripened cheese such as Brie and Camembert; fresh cheese such as cottage cheese, feta cheese, cream cheese, paneer, and curd), processed cheese, processed cheese food, processed cheese product, processed cheese spread, enzyme-modulated cheese; cold-pack cheese), dairy-based sauces (e.g., salad dressing, bechamel sauce, fresh sauces, frozen sauces, refrigerated sauces, shelf stable sauces), dairy spreads (e.g., low-fat spread, low-fat butter), cream (e.g., dry cream, heavy cream, light cream, whipping cream, half-and-half, coffee whitener, coffee creamer, sour cream, crème fraiche), frozen confections (e.g., ice cream, smoothie, milk shake, frozen yogurt, sundae, gelato, custard), dairy desserts (e.g., fresh, refrigerated, or frozen), butter (e.g., whipped butter, cultured butter), dairy powders (e.g., whole milk powder, skim milk powder, fat-filled milk powder (i.e., milk powder comprising plant fat in place of all or some animal fat), infant formula, milk protein concentrate (i.e., protein content of at least 80% by weight; e.g., milk protein concentrate, whey protein concentrate, demineralized whey protein concentrate, β-lactoglobulin concentrate, α-lactalbumin concentrate, glycomacropeptide concentrate, casein concentrate), milk protein isolate (i.e., protein content of at least 90% by weight; e.g., milk protein isolate, whey protein isolate, demineralized whey protein isolate, β-lactoglobulin isolate, α-lactalbumin isolate, glycomacropeptide isolate, casein isolate), nutritional supplements, texturizing blends, flavoring blends, coloring blends, ready-to-drink or ready-to-mix products (e.g., fresh, refrigerated, or shelf stable dairy protein beverages, weight loss beverages, nutritional beverages, sports recovery beverages, and energy drinks), puddings, gels, chewables, crisps, bars (e.g., nutrition bars, protein bars), and fermented dairy products (e.g., yoghurt, cheese, sour cream, cultured buttermilk, cultured butter, cultured butter oil).

The ingestible compositions according to any of the above may be a beverage. Non-limiting examples of beverages include water-based beverages (i.e., beverages that comprise water, such as, for example, plain water, flavored waters, mineral waters, near water drinks, waters comprising natural or synthetic flavor agents, vitamin waters, coconut waters, plant waters, or carbonated waters), carbonated beverages (e.g., cola, ginger ale, soft drinks, root beer, lemon-lime soft drinks), juices (e.g., fruit juices, fruit-flavored juices, vegetable juices, vegetable-flavored juices, a hard lemonade), functional beverages (e.g., sports drinks, energy drinks, meal replacement beverages, weight loss beverages, fluid replacements, nutrition drinks), beverage concentrates (e.g. liquid concentrates), beverage enhancer (e.g. water enhancer drops), teas (e.g., black teas, green teas, red teas, oolong teas, iced tea, hard iced teas), cocoa based beverages (e.g. mochas), dairy-based beverages (i.e., beverages that comprise protein derived from dairy sources (e.g., milk, whey); e.g., milks, smoothies, flavored milks, drinkable yogurts, milk shakes), smoothies, plant milks (e.g., almond milks, soy milks, coconut milks, oat milks, rice milks), alcohol-containing beverages (e.g., kombuchas, wines, beers, ales, cocktails, cocktail mixers), ready to drink beverages, instant powdered beverages, coffee-based beverages, and protein beverages (i.e., beverages that are formulated and/or fortified with a suitable amount of protein [e.g., between about 1% and about 50%, about 45%, about 40%, about 35%, about 30%, about 25%, about 20%, about 15%, about 10%, or about 5%; between about 5% and about 50%, about 45%, about 40%, about 35%, about 30%, about 25%, about 20%, about 15%, or about 10%; between about 10% and about 50%, about 45%, about 40%, about 35%, about 30%, about 25%, about 20%, or about 15%; between about 15% and about 50%, about 45%, about 40%, about 35%, about 30%, about 25%, or about 20%; between about 20% and about 50%, about 45%, about 40%, about 35%, about 30%, or about 25%; between about 25% and about 50%, about 45%, about 40%, about 35%, or about 30%; between about 30% and about 50%, about 45%, about 40%, or about 35%; between about 35% and about 50%, about 45%, or about 40%; between about 40% and about 50%, or about 45%; or between about 45% and about 50% by mass of protein], such as, for example, dairy protein beverages [e.g., skim milk, whole milk, protein-fortified milk, yogurt drinks, high-protein yogurt drinks, shakes, high-protein shakes, beverages comprising recombinant milk proteins (e.g., recombinant whey proteins [e.g., recombinant a-lactalbumin, recombinant β-lactoglobulin, recombinant lactotransferrin, recombinant lactoferricin, recombinant serum albumin protein, recombinant lactoperoxidase protein, recombinant glycomacropeptide], recombinant caseins [e.g., recombinant β-casein, recombinant γ-casein, recombinant κ-casein, recombinant α-S1-casein, recombinant α-S2-casein)], sports drinks, sports recovery beverages, energy drinks, meal replacement beverages. nutrition drinks).

An ingestible composition according to any of the above (e.g., a water-based beverage, a protein beverage, a tabletop sweetener) may comprise between about 15 ppm and about 160 ppm (e.g., between about 15 ppm and about 160 ppm, about 150 ppm, about 140 ppm, about 130 ppm, about 120 ppm, about 110 ppm, about 100 ppm, about 90 ppm, about 80 ppm, about 70 ppm, about 60 ppm, about 50 ppm, about 40 ppm, or about 30 ppm; between about 30 ppm and about 160 ppm, about 150 ppm, about 140 ppm, about 130 ppm, about 120 ppm, about 110 ppm, about 100 ppm, about 90 ppm, about 80 ppm, about 70 ppm, about 60 ppm, about 50 ppm, or about 40 ppm; between about 40 ppm and about 160 ppm, about 150 ppm, about 140 ppm, about 130 ppm, about 120 ppm, about 110 ppm, about 100 ppm, about 90 ppm, about 80 ppm, about 70 ppm, about 60 ppm, or about 50 ppm; between about 50 ppm and about 160 ppm, about 150 ppm, about 140 ppm, about 130 ppm, about 120 ppm, about 110 ppm, about 100 ppm, about 90 ppm, about 80 ppm, about 70 ppm, or about 60 ppm; between about 60 ppm and about 160 ppm, about 150 ppm, about 140 ppm, about 130 ppm, about 120 ppm, about 110 ppm, about 100 ppm, about 90 ppm, about 80 ppm, or about 70 ppm; between about 70 ppm and about 160 ppm, about 150 ppm, about 140 ppm, about 130 ppm, about 120 ppm, about 110 ppm, about 100 ppm, about 90 ppm, or about 80 ppm; between about 80 ppm and about 160 ppm, about 150 ppm, about 140 ppm, about 130 ppm, about 120 ppm, about 110 ppm, about 100 ppm, or about 90 ppm; between about 90 ppm and about 160 ppm, about 150 ppm, about 140 ppm, about 130 ppm, about 120 ppm, about 110 ppm, or about 100 ppm; between about 100 ppm and about 160 ppm, about 150 ppm, about 140 ppm, about 130 ppm, about 120 ppm, or about 110 ppm; between about 110 ppm and about 160 ppm, about 150 ppm, about 140 ppm, about 130 ppm, or about 120 ppm; between about 120 ppm and about 160 ppm, about 150 ppm, about 140 ppm, or about 130 ppm; between about 130 ppm and about 160 ppm, about 150 ppm, or about 140 ppm; between about 140 ppm and about 160 ppm, or about 150 ppm; or between about 150 ppm and about 160 ppm) of brazzein (e.g., recombinant brazzein), and between about 0.5% and about 4% (e.g., between about 0.5% and about 4%, about 3.5%, about 3%, about 2.5%, about 2%, about 1.5%, or about 1%; between about 1% and about 4%, about 3.5%, about 3%, about 2.5%, about 2%, or about 1.5%; between about 1.5% and about 4%, about 3.5%, about 3%, about 2.5%, or about 2%; between about 2% and about 4%, about 3.5%, about 3%, or about 2.5%; between about 2.5% and about 4%, about 3.5%, or about 3%; between about 3% and about 4%, or about 3.5%; or between about 3.5% and about 4%) by mass of one or more bulk sweeteners (e.g., allulose, erythritol, tagatose). The ingestible composition may have a SEV of between about 3.5% and about 12% (e.g., between about 3.5% and about 12%, about 11.5%, about 11%, about 10.5%, about 10%, about 9.5%, about 9%, about 8.5%, about 8%, about 7.5%, about 7%, about 6.5%, about 6%, about 5.5%, about 5%, about 4.5%, or about 4%; between about 4% and about 12%, about 11.5%, about 11%, about 10.5%, about 10%, about 9.5%, about 9%, about 8.5%, about 8%, about 7.5%, about 7%, about 6.5%, about 6%, about 5.5%, about 5%, or about 4.5%; between about 4.5% and about 12%, about 11.5%, about 11%, about 10.5%, about 10%, about 9.5%, about 9%, about 8.5%, about 8%, about 7.5%, about 7%, about 6.5%, about 6%, about 5.5%, or about 5%; between about 5% and about 12%, about 11.5%, about 11%, about 10.5%, about 10%, about 9.5%, about 9%, about 8.5%, about 8%, about 7.5%, about 7%, about 6.5%, about 6%, or about 5.5%; between about 5.5% and about 12%, about 11.5%, about 11%, about 10.5%, about 10%, about 9.5%, about 9%, about 8.5%, about 8%, about 7.5%, about 7%, about 6.5%, or about 6%; between about 6% and about 12%, about 11.5%, about 11%, about 10.5%, about 10%, about 9.5%, about 9%, about 8.5%, about 8%, about 7.5%, about 7%, or about 6.5%; between about 6.5% and about 12%, about 11.5%, about 11%, about 10.5%, about 10%, about 9.5%, about 9%, about 8.5%, about 8%, about 7.5%, or about 7%; between about 7% and about 12%, about 11.5%, about 11%, about 10.5%, about 10%, about 9.5%, about 9%, about 8.5%, about 8%, or about 7.5%; between about 7.5% and about 12%, about 11.5%, about 11%, about 10.5%, about 10%, about 9.5%, about 9%, about 8.5%, or about 8%; between about 8% and about 12%, about 11.5%, about 11%, about 10.5%, about 10%, about 9.5%, about 9%, or about 8.5%; between about 8.5% and about 12%, about 11.5%, about 11%, about 10.5%, about 10%, about 9.5%, or about 9%; between about 9% and about 12%, about 11.5%, about 11%, about 10.5%, about 10%, or about 9.5%; between about 9.5% and about 12%, about 11.5%, about 11%, about 10.5%, or about 10%; between about 10% and about 12%, about 11.5%, about 11%, or about 10.5%; between about 10.5% and about 12%, about 11.5%, or about 11%; between about 11% and about 12%, or about 11.5%; or between about 11.5% and about 12%).

The ingestible composition according to any of the above may be a sugar blend. Non-limiting examples of sugar blends include crystalline white sugar blends, powdered sugar blends, brown sugar blends, cup-for-cup sugar replacers, honey blends, and molasses blends. The food product according to any of the above may be a tabletop sweetener. The sugar blend or tabletop sweetener may comprise one or more ingredients in addition to the flavor blend. For example, the sugar blend or tabletop sweetener may comprise a bulking agent (i.e., a substance that is added to food, pharmaceuticals, or other products to improve volume, bulk, texture, product consistency, mouthfeel, and/or structural support). Non-limiting examples of bulking agents include dextrose, maltodextrin, various soluble and insoluble fibers including polydextrose, inulin, chicory root fiber, psyllium husk, soluble corn fiber (SCF), sugar alcohols such as maltitol, sorbitol, lactitol; and starches including corn starch, tapioca starch, and potato starch.

The ingestible composition according to any of the above may be essentially free of any sweetener/flavor agent other than the brazzein and the one or more additional sweetener/flavor agents comprised in the flavor blend.

The ingestible composition according to any of the above may have a reduced calorie content and/or a reduced glycemic index compared to a corresponding ingestible composition (i.e., an ingestible composition that is identical to the ingestible composition that is being compared to the “corresponding ingestible composition” and has the same SEV as the ingestible composition except that it does not comprise a flavor blend according to any of the above but a sugar [e.g., sucrose, glucose, lactose]). The ingestible composition according to any of the above may be low-calorie (e.g., have less than 40 calories per 8 oz serving) or zero-calorie (e.g., have less than 5 calories per 8 oz serving).

### Method for Producing Flavor Blend

In various aspects, provided herein is a method for producing a flavor blend according to any of the above, wherein the method comprises combining an amount of brazzein with an amount of one or more additional sweetener/flavor agents, wherein the amount of brazzein and the amount of the one or more additional sweetener/flavor agents are chosen to provide a desired sensory profile (e.g., a sensory profile as provided herein).

The brazzein may be a native brazzein and/or a non-native brazzein (e.g., a brazzein comprising one or more amino acid substitutions, deletions, or additions), and may have a sequence identity of at least 85%, at least 90%, at least 95%, at least 97%, or 100% to SEQ ID NO: 1,2, or 3.

The brazzein may be obtained using methods known in the art. For example, the brazzein may be extracted from a natural source (e.g., any of the natural sources disclosed herein). As a further example, the brazzein may be a recombinant brazzein. Recombinant brazzein may be obtained using in vitro methods (e.g., using cell-free transcription and/or translation systems). Alternatively, recombinant brazzein may be produced using a recombinant host cell. Methods for producing recombinant proteins are known in the art (see, for example, PCT filing PCT/US2015/046428 filed Aug. 21, 2015, PCT filing PCT/US2017/48730 filed Aug. 25, 2017, PCT filing PCT/US2021/018899 filed Feb. 18, 2021; and Example 1).

The recombinant host cell may be derived from any wildtype organism, including any bacterium, fungus (e.g., yeast, filamentous fungus), archaea, unicellular protista, animal, plant, algae, protozoan, and chromista, or from a genetic variant (e.g., mutant) thereof, as well as from any generally recognized as safe (GRAS) industrial host cell.

Non-limiting examples of suitable bacteria include firmicutes, cyanobacteria (blue-green algae), oscillatoriophcideae, bacillales, lactobacillies, oscillatoriales, bacillaceae, lactobacillus, and members of any of the following genera, and derivatives and crosses thereof: Acinetobacter, Acetobacter (e.g., Acetobacter suboxydans, Acetobacter xylinum), Actinoplane (e.g., Actinoplane missouriensis), Arthrospira (e.g., Arthrospira platensis, Arthrospira maxima), Bacillus (e.g., Bacillus cereus, Bacillus coagulans, Bacillus licheniformis, Bacillus stearothermophilus, Bacillus subtilis), Escherichia (e.g., Escherichia coli), Lactobacillus (e.g., Lactobacillus acidophilus, Lactobacillus bulgaricus), Lactococcus (e.g., Lactococcus lactis, Lactococcus lactis Lancefield Group N, Lactobacillus reuteri), Leuconostoc (e.g., Leuconostoc citrovorum, Leuconostoc dextranicum, Leuconostoc mesenteroides), Micrococcus (e.g., Micrococcus lysodeikticus), Rhodococcus (e.g., Rhodococcus opacus, Rhodococcus opacus strain PD630), Spirulina, Streptococcus (e.g., Streptococcus cremoris, Streptococcus lactis, Streptococcus lactis subspecies diacetylactis, Streptococcus thermophilus), Streptomyces (e.g., Streptomyces chattanoogensis, Streptomyces griseus, Streptomyces natalensis, Streptomyces olivaceus, Streptomyces olivochromogenes, Streptomyces rubiginosus), Tetrahymena (e.g., Tetrahymena thermophile, Tetrahymena hegewischi, Tetrahymena hyperangularis, Tetrahymena malaccensis, Tetrahymena pigmentosa, Tetrahymena pyriformis, Tetrahymena vorax), and Xanthomonas (e.g., Xanthomonas campestris).

Non-limiting examples of suitable yeast include members of any of the following genera, and derivatives and crosses thereof: Blastobotrys, Candida (e.g., Candida albicans, Candida etchellsii, Candida guilliermondii, Candida humilis, Candida lipolytica, Candida orthopsilosis, Candida palmioleophila, Candida pseudotropicalis, Candida sp., Candida utilis, Candida versatilis), Cladosporium, Cryptococcus (e.g., Cryptococcus terricolus, Cryptococcus curvatus), Debaryomyces (e.g., Debaryomyces hansenii), Endomyces (e.g., Endomyces vernalis), Endomycopsis (e.g., Endomycopsis vernalis), Eremothecium (e.g., Eremothecium ashbyii), Hansenula (e.g., Hansenula sp., Hansenula polymorpha), Kluyveromyces (e.g., Kluyveromyces sp., Kluyveromyces lactis, Kluyveromyces marxianus var. lactis, Kluyveromyces marxianus, Kluyveromyces thermotolerans), Lipomyces (e.g., Lipomyces starkeyi, Lipomyecs lipofer), Ogataea (e.g., Ogataea minuta), Pichia (e.g., Pichia sp., Pichia pastoris, Pichia finlandica, Pichia trehalophila, Pichia koclamae, Pichia membranaefaciens, Pichia minuta, Pichia lindneri), Pichia opuntiae, Pichia thermotolerans, Pichia salictaria, Pichia guercuum, Pichia pijperi, Pichia stiptis, Pichia methanolica), Rhodosporidium (e.g., Rhodosporidium toruloides), Rhodotorula (e.g., Rhodotorula sp., Rhodotorula gracilis, Rhodotorula glutinis, Rhodotorula graminis), Saccharomyces (e.g., Saccharomyces sp., Saccharomyces bayanus, Saccharomyces beticus, Saccharomyces cerevisiae, Saccharomyces chevalieri, Saccharomyces diastaticus, Saccharomyces ellipsoideus, Saccharomyces exiguus, Saccharomyces florentinus, Saccharomyces fragilis, Saccharomyces pastorianus, Saccharomyces pombe, Saccharomyces sake, Saccharomyces uvarum), Sporobolomyces (e.g., Sporobolomyces roseus), Sporidiobolus (e.g., Sporidiobolus johnsonii, Sporidiobolus salmonicolor), Trichosporon (e.g., Trichosporon cacaoliposimilis, Trichosporon oleaginosus sp. nov., Trichosporon cacaoliposimilis sp. nov., Trichosporon gracile, Trichosporon dulcitum, Trichosporon jirovecii, Trichosporon insectorum), Xanthophyllomyces (e.g., Xanthophyllomyces dendrorhous), Yarrowia (e.g., Yarrowia lipolytica), and Zygosaccharomyces (e.g., Zygosaccharomyces rouxii).

Non-limiting examples of suitable filamentous fungi include any holomorphic, teleomorphic, and anamorphic forms of fungi, including members of any of the following genera, and derivatives and crosses thereof: Acremonium (e.g., Acremonium alabamense), Aspergillus (e.g., Aspergillus aculeatus, Aspergillus awamori, Aspergillus clavatus, Aspergillus flavus, Aspergillus foetidus, Aspergillus fumigatus, Aspergillus japonicus, Aspergillus nidulans, Aspergillus niger, Aspergillus niger var. awamori, Aspergillus ochraceus, Aspergillus oryzae, Aspergillus sojae, Aspergillus terreus, as well as Emericella, Neosartorya, and Petromyces species), Aureobasidium, Canariomyces, Chaetomium, Chaetomidium, Corynascus, Chrysosporium (e.g., Chrysosporium botryoides, Chrysosporium carmichaeli, Chrysosporium crassitunicatum, Chrysosporium europae, Chrysosporium evolceannui, Chrysosporium farinicola, Chrysosporium fastidium, Chrysosporium filiforme, Chrysosporium georgiae, Chrysosporium globiferum, Chrysosporium globiferum var. articulatum, Chrysosporium globiferum var. niveum, Chrysosporium hirundo, Chrysosporium hispanicum, Chrysosporium holmii, Chrysosporium indicum, Chrysosporium iops, Chrysosporium keratinophilum, Chrysosporium kreiselii, Chrysosporium kuzurovianum, Chrysosporium lignorum, Chrysosporium obatum, Chrysosporium lucknowense, Chrysosporium lucknowense Garg 27K, Chrysosporium medium, Chrysosporium medium var. spissescens, Chrysosporium mephiticum, Chrysosporium merdarium, Chrysosporium merdarium var. roseum, Chrysosporium minor, Chrysosporium pannicola, Chrysosporium parvum, Chrysosporium parvum var. crescens, Chrysosporium pilosum, Chrysosporium pseudomerdarium, Chrysosporium pyriformis, Chrysosporium queenslandicum, Chrysosporium sigleri, Chrysosporium sulfureum, Chrysosporium synchronum, Chrysosporium tropicum, Chrysosporium undulatum, Chrysosporium vallenarense, Chrysosporium vespertilium, Chrysosporium zonatum), Coonemeria, Cunninghamella (e.g., Cunninghamella ehinulata), Dactylomyces, Emericella, Filibasidium, Fusarium (e.g., Fusarium moniliforme, Fusarium venenatum, Fusarium oxysporum, Fusarium graminearum, Fusarium proliferatum, Fusarium verticiollioides, Fusarium culmorum, Fusarium crookwellense, Fusarium poae, Fusarium sporotrichioides, Fusarium sambuccinum, Fusarium torulosum, as well as associated Gibberella teleomorphic forms thereof), Gibberella, Humicola, Hypocrea, Lentinula, Malbranchea (e.g., Malbranchea filamentosa), Magnaporthe, Malbranchium, Melanocarpus, Mortierella (e.g., Mortierella alpina 1S-4, Mortieralla isabelline, Mortierrla vinacea, Mortieralla vinaceae var. raffinoseutilizer), Mucor (e.g., Mucor miehei Cooney et Emerson (Rhizomucor miehei (Cooney & R. Emerson)) Schipper, Mucor pusillus Lindt, Mucor circinelloides Mucor mucedo), Myceliophthora (e.g., Myceliophthora thermophila), Myrothecium, Neocallimastix, Neurospora (e.g., Neurospora crassa), Paecilomyces, Penicillium (e.g., Penicillium chrysogenum, Pennicillium iilacinum, Penicillium roquefortii), Phenerochaete, Phlebia, Piromyces, Pythium, Rhizopus (e.g., Rhizopus niveus), Schizophyllum, Scytalidium, Sporotrichum (e.g., Sporotrichum cellulophilum), Stereum, Talaromyces, Thermoascus, Thermomyces, Thielavia (e.g., Thielavia terrestris), Tolypocladium, and Trichoderma (e.g., Trichoderma harzianum, Trichoderma koningii, Trichoderma longibrachiatum, Trichoderma reesei, Trichoderma atroviride, Trichoderma virens, Trichoderma citrinoviride, Trichoderma viride).

Non-limiting examples of suitable plants include cycads, ginkgo biloba, conifers, cypress, junipers, thuja, cedarwood, pines, angelica, caraway, coriander, cumin, fennel, parsley, dill, dandelion, helichrysum, marigold, mugwort, safflower, camomile, lettuce, wormwood, calendula, citronella, sages, thyme, chia seed, mustard, olive, coffee, capsicum, eggplant, paprika, cranberry, kiwi, vegetables (e.g., carrot, celery), tagetes, tansy, tarragon, sunflower, wintergreen, basil, hyssop, lavender, lemon verbena, marjoram, melissa, patchouli, pennyroyal, peppermint, rosemary, sesame, spearmint, primroses, samara, pepper, pimento, potato, sweet potato, tomato, blueberry, nightshades, petunia, morning glory, lilac, jasmin, honeysuckle, snapdragon, psyllium, wormseed, buckwheat, amaranth, chard, quinoa, spinach, rhubarb, jojoba, cypselea, chlorella, marula, hazelnut, canola, kale, bok choy, rutabaga, frankincense, myrrh, elemi, hemp, pumpkin, squash, curcurbit, manioc, dalbergia, legume plants (e.g., alfalfa, lentils, beans, clovers, peas, fava coceira, frijole bola roja, frijole negro, lespedeza, licorice, lupin, mesquite, carob, soybean, peanut, tamarind, wisteria, cassia, chickpea/garbanzo, fenugreek, green pea, yellow pea, snow pea, lima bean, fava bean), geranium, flax, pomegranate, cotton, okra, neem, fig, mulberry, clove, eucalyptus, tea tree, niaouli, fruiting plants (e.g., apple, apricot, peach, plum, pear, nectarine), strawberry, blackberry, raspberry, cherry, prune, rose, tangerine, citrus (e.g., grapefruit, lemon, lime, orange, bitter orange, mandarin, tangerine), mango, citrus bergamot, buchu, grape, broccoli, brussels sprout, camelina, cauliflower, rape, rapeseed (canola), turnip, cabbage, cucumber, watermelon, honeydew melon, zucchini, birch, walnut, cassava, baobab, allspice, almond, breadfruit, sandalwood, macadamia, taro, tuberose, aloe vera, garlic, onion, shallot, vanilla, yucca, vetiver, galangal, barley, corn, curcuma aromatica, ginger, lemon grass, oat, palm, pineapple, rice, rye, sorghum, triticale, turmeric, yam, bamboo, barley, cajuput, canna, cardamom, maize, oat, wheat, cinnamon, sassafras, lindera benzoin, bay laurel, avocado, ylang-ylang, mace, nutmeg, moringa, horsetail, oregano, cilantro, chervil, chive, aggregate fruits, grain plants, herbal plants, leafy vegetables, non-grain legume plants, nut plants, succulent plants, land plants, water plants, delbergia, millets, drupes, schizocarps, flowering plants, non-flowering plants, cultured plants, wild plants, trees, shrubs, flowers, grasses, herbaceous plants, brushes, lianas, cacti, tropical plants, subtropical plants, temperate plants, moss (e.g., Physcomitrella patens), and derivatives and crosses thereof.

The brazzein may be purified (i.e., be substantially separated from chemicals (e.g., carbohydrates, lipids, ash, metabolites, signaling molecules, other proteins), cellular components (e.g., cell walls, membrane lipids, chromosomes), and cells (e.g., other cells in an organism) of the source material from which the brazzein originated) comprised in a source material [e.g., a plant material, a fermentation broth]). For example, the brazzein may be purified to a purity of greater than 30%, greater than 35%, greater than 40%, greater than 45%, greater than 50%, greater than 55%, greater than 60%, greater than 65%, greater than 70%, greater than 75%, greater than 80%, greater than 85%, greater than 90%, greater than 95%, greater than 97%, or greater than 99% relative to other components comprised in the source material, or to at least 2-fold, at least 3-fold, at least 4-fold, at least 5-fold, at least 6-fold, at least 7-fold, at least 8-fold, at least 9-fold, or at least 10-fold greater abundancy relative to other components comprised in the source material, or to a purity of greater than 30%, greater than 35%, greater than 40%, greater than 45%, greater than 50%, greater than 55%, greater than 60%, greater than 65%, greater than 70%, greater than 75%, greater than 80%, greater than 85%, greater than 90%, greater than 95%, greater than 97%, or greater than 99% by weight.

The one or more additional sweetener/flavor agents may comprise or consist of one or more nutritive sweeteners (e.g., any of the nutritive sweeteners disclosed herein), one or more high-potency sweeteners (e.g., any of the high-potency sweeteners disclosed herein), one or more sweet-tasting amino acids (e.g., any of the sweet-tasting amino acids disclosed herein), one or more bulk sweeteners (e.g., any of the bulk sweeteners disclosed herein), one or more acidulants (e.g., any of the acidulants disclosed herein), or one or more other sweetener/flavor agents. For example, the one or more additional sweetener/flavor agents may comprise or consist of allulose. Allulose can be extracted from a natural source (e.g., any of the natural sources disclosed herein), or can be produced using methods known in the art (see, for example, Suwei Jiang et. al. “Review on D-Allulose: In vivo Metabolism, Catalytic Mechanism, Engineering Strain Construction, Bio-Production Technology” In: Frontiers in Bioengineering and Biotechnology, 2020, Vol. 8, Art. 26). As a further example, the one or more additional sweetener/flavor agents may comprise or consist of erythritol. Erythritol can be extracted from a natural source (e.g., any of the natural sources disclosed herein), or can be produced using methods known in the art (see for example, Frédéric Carly et. al. “Erythritol production by yeasts: a snapshot of current knowledge” In: Yeast, 2018, Vol. 35, Iss. 7, p. 445-484). As a further example, the one or more additional sweetener/flavor agents may comprise or consist of tagatose. Tagatose can be extracted from a natural source (e.g., any of the natural sources disclosed herein), or can be produced using methods known in the art (see, for example, Sohini Roy et. al. “Tagatose as a Potential Nutraceutical: Production, Properties, Biological Roles, and Applications” In: Concise Reviews & Hypotheses in Food Science, Journal of Food Science, 2018, Vol. 83, Iss. 11, p. 2699-2709). The one or more additional sweetener/flavor agents may be purified. For example, the one or more additional sweetener/flavor agents may be purified to a purity of greater than 30%, greater than 35%, greater than 40%, greater than 45%, greater than 50%, greater than 55%, greater than 60%, greater than 65%, greater than 70%, greater than 75%, greater than 80%, greater than 85%, greater than 90%, greater than 95%, greater than 97%, or greater than 99% relative to other components comprised in the source material, or to at least 2-fold, at least 3-fold, at least 4-fold, at least 5-fold, at least 6-fold, at least 7-fold, at least 8-fold, at least 9-fold, or at least 10-fold greater abundancy relative to other components comprised in the source material, or to a purity of greater than 30%, greater than 35%, greater than 40%, greater than 45%, greater than 50%, greater than 55%, greater than 60%, greater than 65%, greater than 70%, greater than 75%, greater than 80%, greater than 85%, greater than 90%, greater than 95%, greater than 97%, or greater than 99% by weight.

### Method for Conferring Sensory Profile on Ingestible Composition

In various aspects, provided herein is a method for conferring a desired sensory profile on an ingestible composition, wherein the method comprises: preparing the ingestible composition using an amount of a flavor blend according to any of the above (e.g., combining the flavor blend with other ingredients comprised in the composition), and/or adding to the composition an amount of a flavor blend according to any of the above. The amount of the flavor blend may be chosen to provide a SEV of between about 3.5% and about 12% (e.g., between about 3.5% and about 12%, about 11.5%, about 11%, about 10.5%, about 10%, about 9.5%, about 9%, about 8.5%, about 8%, about 7.5%, about 7%, about 6.5%, about 6%, about 5.5%, about 5%, about 4.5%, or about 4%; between about 4% and about 12%, about 11.5%, about 11%, about 10.5%, about 10%, about 9.5%, about 9%, about 8.5%, about 8%, about 7.5%, about 7%, about 6.5%, about 6%, about 5.5%, about 5%, or about 4.5%; between about 4.5% and about 12%, about 11.5%, about 11%, about 10.5%, about 10%, about 9.5%, about 9%, about 8.5%, about 8%, about 7.5%, about 7%, about 6.5%, about 6%, about 5.5%, or about 5%; between about 5% and about 12%, about 11.5%, about 11%, about 10.5%, about 10%, about 9.5%, about 9%, about 8.5%, about 8%, about 7.5%, about 7%, about 6.5%, about 6%, or about 5.5%; between about 5.5% and about 12%, about 11.5%, about 11%, about 10.5%, about 10%, about 9.5%, about 9%, about 8.5%, about 8%, about 7.5%, about 7%, about 6.5%, or about 6%; between about 6% and about 12%, about 11.5%, about 11%, about 10.5%, about 10%, about 9.5%, about 9%, about 8.5%, about 8%, about 7.5%, about 7%, or about 6.5%; between about 6.5% and about 12%, about 11.5%, about 11%, about 10.5%, about 10%, about 9.5%, about 9%, about 8.5%, about 8%, about 7.5%, or about 7%; between about 7% and about 12%, about 11.5%, about 11%, about 10.5%, about 10%, about 9.5%, about 9%, about 8.5%, about 8%, or about 7.5%; between about 7.5% and about 12%, about 11.5%, about 11%, about 10.5%, about 10%, about 9.5%, about 9%, about 8.5%, or about 8%; between about 8% and about 12%, about 11.5%, about 11%, about 10.5%, about 10%, about 9.5%, about 9%, or about 8.5%; between about 8.5% and about 12%, about 11.5%, about 11%, about 10.5%, about 10%, about 9.5%, or about 9%; between about 9% and about 12%, about 11.5%, about 11%, about 10.5%, about 10%, or about 9.5%; between about 9.5% and about 12%, about 11.5%, about 11%, about 10.5%, or about 10%; between about 10% and about 12%, about 11.5%, about 11%, or about 10.5%; between about 10.5% and about 12%, about 11.5%, or about 11%; between about 11% and about 12%, or about 11.5%; or between about 11.5% and about 12%).

The desired sensory profile conferred upon the ingestible composition may be a sensory profile that is similar or identical to that conferred upon the ingestible composition by addition of a sugar (e.g., sucrose, fructose, glucose, lactose).

The desired sensory profile conferred upon the ingestible composition may be a sensory profile that is similar or identical to that conferred upon a corresponding ingestible composition (i.e., an ingestible composition that is identical to the ingestible composition that is being compared to the “corresponding ingestible composition” and has the same SEV as the ingestible composition except that it does not comprise a flavor blend according to any of the above but a sugar [e.g., sucrose, glucose, lactose]). Such similarity or identity may be a similar or identical maximum sweetness intensity, similar or identical duration to onset of sweetness, similar or identical duration to reach maximum sweetness intensity, similar or identical duration of lingering sweet aftertaste, and/or similar or identical average ranked preference score.

### EXAMPLES

The following examples are included to illustrate specific aspects of this disclosure. The techniques disclosed in the examples represent techniques discovered by the inventors to function well in the methods and processes of this disclosure; however, those of skill in the art should, in light of the present disclosure, appreciate that many changes can be made in the specific aspects that are disclosed and still obtain a like or similar result without departing from the spirit and scope of the disclosure. Therefore, all matter set forth or shown in the examples is to be interpreted as illustrative and not in a limiting sense.

### Example 1: Production of Recombinant Brazzein

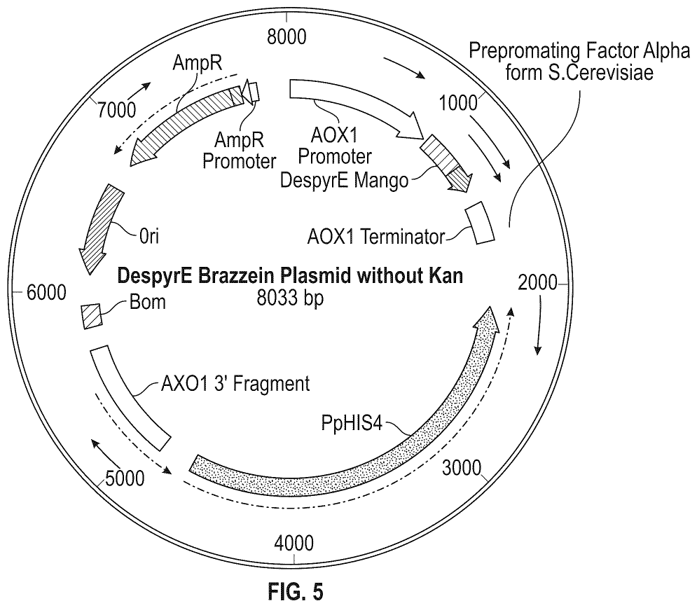

For recombinant protein expression of brazzein, the recombinant vector shown in FIG. 5 was constructed from vector pPic9K (ThermoFischer Scientific, Waltham, MA) using genetic engineering methods known in the art. The recombinant vector comprised an expression construct comprising a protein coding sequence encoding des-pyrE-brazzein (SEQ ID NO: 2); codon-optimized for expression in Pichia pastoris (Komagataella phaffii); operably linked to an N-terminal secretion signal (i.e., pre or pre-pro signal peptide of the alpha mating factor of Saccharomyces cerevisiae), and under control of the AOX1 promoter (also used as 5′flanking end), which is inducible by methanol, and AOX1 terminator. The recombinant vector also comprised a His4 gene complement auxotrophy, and a AOX1 3′-region as flanking end, an origin of replication for plasmid propagation in bacteria, and an ampicillin gene as cloning selection marker.

The recombinant vector was digested with BglII restriction enzyme to remove E. coli components such as the origin of replication and ampicillin selection marker, and was then transformed into Pichia pastoris (Komagataella phaffii; e.g., strain BG12 [(Biogrammatics, Carlsbad, CA]) host cells. Transformants were selected on YNB agar medium containing 1× Yeast Nitrogen Base w/o amino acids, 2% dextrose, and 2% agar. Transformants were then grown in 96-well plates, and supernatants were harvested for further analysis. Recombinant host cells that comprised an integrated copy of the expression construct and that secreted a recombinant brazzein were identified by SDS-PAGE gel analyses of fermentation broth samples.

Recombinant host cells were then fermented in a traditional batch process, which involved a pre-seed and seed generation in YPG medium for about 12 to 14 hours for each stage. The seed was transferred to a bioreactor with Basal Salt Medium (BSM) with glycerol as the major carbon source. The reactor conditions were maintained at a temperature of 30° C. and a pH of 5.5 using 25% ammonia. Once the glycerol was consumed completely, the fermentation was moved to a fed-batch process. At this stage, glycerol was fed continuously until the biomass reached 250-300 g/L, which marked the beginning of the glycerol-methanol transition phase, wherein a mixed feed of methanol and glycerol was carried out for 2-3 hours to adapt the host cell's metabolism to the presence of methanol. The transition phase was followed by an induction phase, wherein glycerol (AOX inhibitor) was completely utilized, and the sole source of carbon was methanol. The batch was harvested at 120 hours post induction, and the broth was harvested.

Biomass was separated by plate and frame filtration, or continuous centrifugation, and the cell free supernatant was filtered via a microfilter of size 0.1 micron. The microfilter retentate was dia-filtered to recover >90% of protein. The microfiltered permeate was taken for 3KDd ultrafiltration to remove higher molecular weight protein impurities, after which the ultrafilter permeate was taken to 1KD or 3KD or 5KD ultrafilter for concentration and diafiltration. The filtered material was further processed through a column or column-free process, then concentrated using 2KD ultrafiltration, and sterilized by passing through a 0.2 micron filter. The sterile material was lyophilized. The final brazzein purity was >95%. Unlike some stevia sweeteners (e.g., RebD), the recombinant brazzein was readily soluble (solubility of 5% [50 mg/ml] at room temperature).

### Example 2: Determination of Sweetness, Taste, and Mouthfeel of Recombinant Brazzein. Concentration Response Curve

Two batches (Batch 004 and Batch 009) of the recombinant brazzein of Example 1 were evaluated for sweetness intensity by a panel of 7 human sensory experts. The recombinant brazzein was dissolved at various concentrations (20, 40, 60, 80, 100, and 120 mg/l) in spring water (Ice Mountain, MI). A series of sucrose reference standards ranging from 3% to 12% sucrose (Crystal Sugar, Moorhead, MN) in 0.5% increments was also prepared. All recombinant brazzein samples (test samples) and sucrose reference standards (reference standards) were served in 2-oz soufflé cups at room temperature. Water and saltine crackers were provided for rinsing between samples. Test samples were labeled with a random 3-digit code, and two test samples were evaluated at each sitting. A set of 5 labeled reference standards approximately bracketing the sweetness of the test samples was provided with the test samples for each evaluation.

The human sensory experts ware selected and trained to perform sensory evaluation as described in ASTM Committee E-18, Guidelines for the Selection and Training of Sensory Panel Members, STP 758, American Society for Testing and Materials, Philadelphia, 1981. The sensory experts performed descriptive analyses of the samples using the sensory profile method as described in ASTM Committee E-18, Descriptive Analysis Testing for Sensory Evaluation, MNL 31, R. C. Hootman, ed., Baltimore, 1992. The sensory experts were asked to taste each blind coded test sample, compare the sweetness intensity to the reference standards, then assign a sweetness intensity score to the nearest 0.1 unit. All test samples were evaluated in duplicate.

The panel-generated sweetness intensity values were plotted against their respective brazzein concentrations, and a best-fitting Beidler curve was generated. The equation for this curve, which allows for calculation of the best estimate of sweetness intensity at any brazzein concentration in the range tested, was reported for each curve.

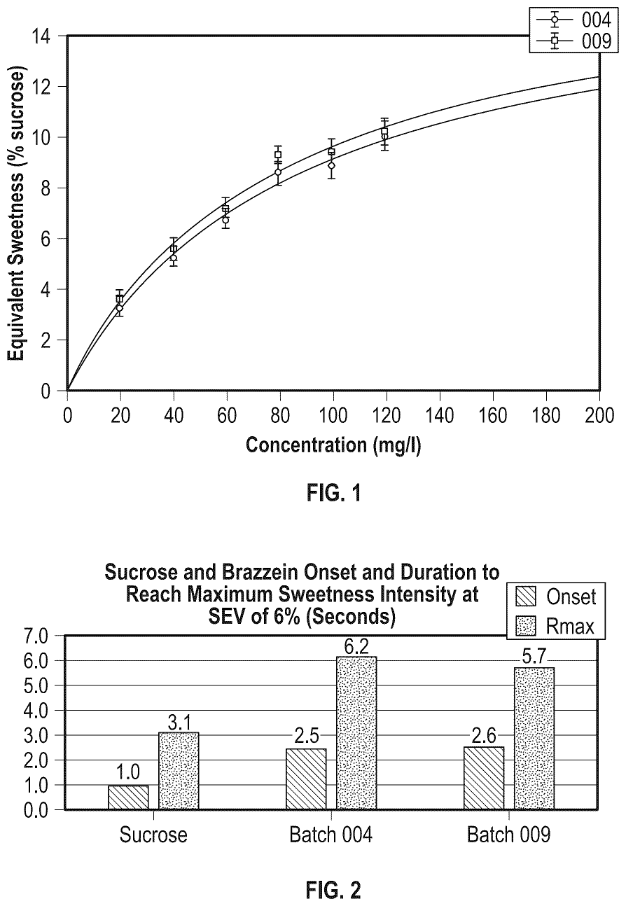

As shown in FIG. 1, the SEV of the recombinant brazzein increased with concentration in non-linear fashion. For example, at a SEV of 2%, which is near the taste threshold for sweetness, the potency of the recombinant brazzein was about 1,700 times as high as that of sucrose; at a SEV of 5%, the potency of the recombinant brazzein was between about 1,400 and about 1,500 times as high as that of sucrose; and at a SEV of 10%, which is the sweetness of many carbonated soft drinks, the potency of the recombinant brazzein was about 800 times as high as that of sucrose. Overall, the recombinant brazzein reached a SEV of above 10% in the concentration range tested, with a theoretical maximum intensity of about 16.9% SE.

### Descriptive Analysis

Solutions of brazzein (test samples) were prepared at 50 ppm, a SEV of about 6%, in spring water (Ice Mountain, MI). The test samples were presented in 2-oz soufflé cups labeled with a random 3-digit code and evaluated at room temperature. A panel of 6 human sensory experts tasted the test samples in a training session to identify and discuss non-sweet attributes detected in the test samples, practice scoring the attributes, and calibrate using a 60-point (16 cm) line scale graduated in evenly spaced 5-point increments and labeled low (0) to high (60). After training, blind, coded test samples were evaluated and scored independently by the sensory experts. Average intensity scores for each attribute were calculated and analyzed using ANOVA at 95% confidence level.

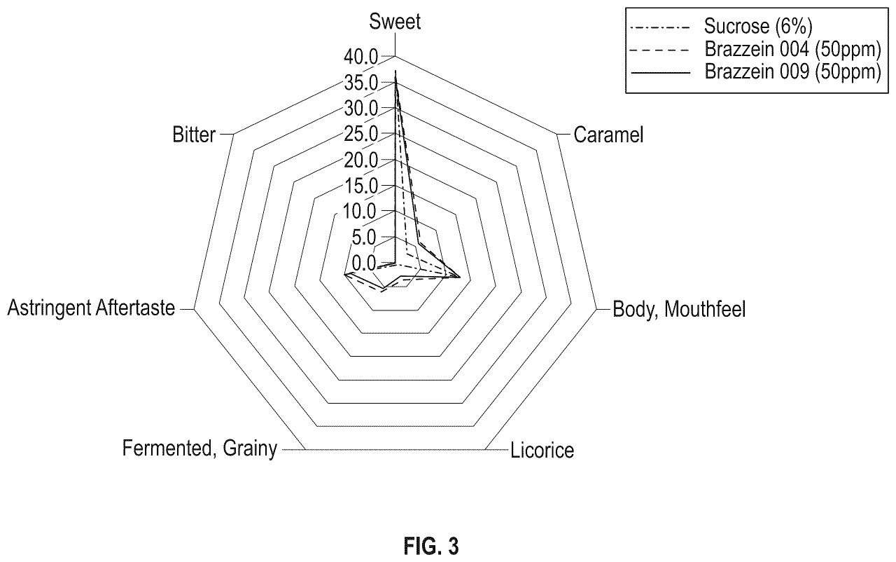

As shown in FIG. 3, the taste characteristics of the recombinant brazzein was primarily sweet, with faint caramel notes, a trace of licorice, and astringent aftertaste, with no bitterness.

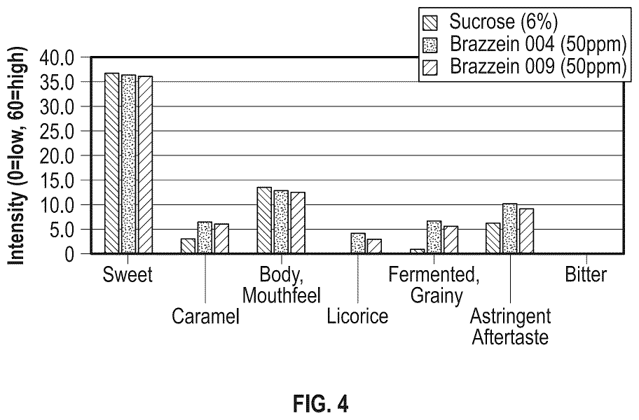

As shown in FIG. 4, the recombinant brazzein imparted a perception of body and mouthfeel similar to that imparted by 6% sucrose.

### Temporal Properties

Solutions of brazzein (test samples) were prepared at 50 ppm, a SEV of about 6%, in spring water (Ice Mountain, MI). The test samples were presented as described above. A panel of 8 human sensory experts was trained on technique, and then, using a timer, evaluated the duration to onset of sweetness and duration to reach maximum sweetness intensity. The intensity of sweetness decay after expectorating was measured every 5 seconds using the 60-point line scale described above.

As shown in FIG. 2, the recombinant brazzein had a considerably slower onset of sweetness than sucrose (about 2.5 seconds compared to about 1 second), and a longer duration to reach maximum sweetness intensity (about 6 seconds compared about 3 seconds). The sweetness decay of brazzein was slightly slower than that of sucrose at about 38 seconds after expectorating compared to about 25 seconds for sucrose. As a result, brazzein had a slight lingering sweet aftertaste.

### Example 3: Blending Brazzein with Sweetener/Flavor Agent

Table 1 provides formulations for blending brazzein with sucrose to achieve various levels of sugar reduction in a food product (e.g., beverage) application while maintaining a SEV of 10%.

TABLE I
Equisweet Blends of Brazzein with Sucrose
to Achieve Sugar Reduction at 10% SEV

| % Sugar Reduction | 0 | 25 | 50 | 75 | 100 |
|---|---|---|---|---|---|
| Sucrose (%) | 100 | 75 | 50 | 25 | 0 |
| Brazzein (e.g., recombinant | 0 | 68 | 36 | 15 | 125 |
| brazzein of Example 1) (ppm) | | | | | |

Table 2 provides formulations for blending brazzein with erythritol to accelerate duration to onset of sweetness and duration to reach maximum sweetness intensity while maintaining a SEV of 6%.

TABLE 2
Duration to Onset of Sweetness (Onset) and Duration to Reach Maximum
Sweetness Intensity (Rmax) for Equisweet Brazzein (B; e.g., recombinant
brazzein of Example 1) and Erythritol (E) Blends at 6% SEV

| Sweetness Ratio (%) | 100S | 100E/0B | 70E/30B | 50E/50B | 30E/70B | 0E/100B |
|---|---|---|---|---|---|---|
| Onset (seconds) | 1.1 | 1.3 | 1.8 | 1.9 | 2.4 | 2.4 |
| Rmax (seconds) | 2.8 | 2.6 | 3.8 | 4.3 | 4.6 | 5.6 |

### Example 4: Blending Brazzein with Acidulants

Brazzein may be blended with acidulants, in appropriate proportions to produce a desired balance between sweet and sour tastes. Acidulants, just like sweeteners, may vary in their temporal properties. For example, citric acid has a quick onset of sourness, and a rapid duration to reach maximum sweetness intensity. The temporal properties of sour taste imparted by citric acid mirror those of sweet taste imparted by sucrose, creating a sweet/sour balance in sucrose and citric acid blends that is desired by consumers (e.g., in beverages).

As shown above, the temporal sweetness profile of brazzein differs from that of sucrose. Formulating a beverage with brazzein and citric acid thus creates a mismatch in sweet and sour tastes that consists of an unpleasantly sour initial impression (due to the delayed onset of sweetness of brazzein), followed by an unbalanced sweet mid-taste (as brazzein reaches its maximum sweetness intensity, and the sourness of citric acid has already decayed).

Blending brazzein with an acidulant that has a slower onset of sourness and a longer duration to reach maximum sourness can yield a more well-rounded taste profile. Table 3 provides a lemonade-flavored beverage formulation in which a blend of malic acid and lactic acid is used to replace some of the citric acid that is typically comprised in such composition to yield a desirable balanced sweet/sour taste profile. The formulation can be readily adapted to yield a dry-mix powdered beverage that may be combined with water to yield the beverage.

TABLE 3
Lemonade-Flavored Soft Drink Sweetened
with Brazzein to a SEV of about 11%

| Ingredients | % (w/w) |
|---|---|
| Water | 99.4600 |
| Natural Lemonade Type Flavor 862.00886 (FONA, | 0.2000 |
| Hoffman Estates, IL, USA) | |
| Potassium sorbate (Brenntag North America, Inc, | 0.1000 |
| Reading, PA, USA) | |
| Citric acid, anhydrous (Cargill, Minneapolis, MN, USA) | 0.0800 |
| Malic acid, 50% (Hawkins Inc., Minneapolis, MN, USA) | 0.0800 |
| L-Lactic acid, 85% (Hawkins Inc., Minneapolis, MN, USA) | 0.0500 |
| Brazzein (e.g., recombinant brazzein of Example 1) | 0.0200 |
| Turmeric oleoresin (Sensient, Hoffman Estates, IL, USA) | 0.0100 |

### Example 5: Flavor Blends Comprising Brazzein in Water

The sensory profile of a flavor blend comprising brazzein alone was compared with the sensory profiles of flavor blends comprising brazzein combined with allulose, erythritol, or tagatose when dissolved in water. Sensory profiles were characterized by duration to onset of sweetness, duration to reach maximum sweetness intensity, duration of lingering sweet aftertaste, and average ranked preference score, which were measured as per the procedure on page 351 in “Sensory Evaluation of Food Principles and Practices”, H.T Lawless & H. Heymann (Editors), published by Chapman & Hall, New York & London, in 1998). Specifically, each set of samples was evaluated by a panel of 6-8 human sensory experts. The sensory experts measured the duration to onset of sweetness and duration to reach maximum sweetness intensity using a timer. Duration of lingering sweet aftertaste was measured by rating sweetness intensity every 5 seconds on a 15-cm line scale graduated in evenly spaced 5-point increments and labeled low (0) to high (60). The sensory experts were also asked to rank all samples in order of preference, with 1 being their most preferred sample, and 5 being their least preferred sample. A sucrose sample was used for comparison purposes. Samples were served at room temperature in 4-oz soufflé cups, labeled with random 3-digit codes. Water and saltine crackers were provided for rinsing between samples.

As shown in Table 4, brazzein combined with allulose, erythritol, or tagatose in equisweet flavor blends dissolved in water had reduced duration to onset of sweetness, reduced duration of lingering sweet aftertaste, reduced duration to reach maximum sweetness intensity, and/or lower average ranked preference score. In sum, the sensory profile of flavor blends comprising brazzein combined with these bulk sweeteners more closely resembled the sensory profile of sucrose than did the sensory profile of the flavor blend that comprised brazzein alone.

TABLE 4
Sensory Profile of Flavor Blends Dissolved in Water

| Flavor | | Bulk | Onset of | | Lingering Sweet | | Reach Max. | | Average |
|---|---|---|---|---|---|---|---|---|---|
| Blend | Brazzein | Sweetener - | Sweetness | | Aftertaste | | Sweetness Intensity | | Ranked |
| Sample | Conc. | Conc. | Duration | Reduction | Duration | Reduction | Duration | Reduction | Preference |
| No. | (ppm) | (%) | (Sec) | (%) | (Sec) | (%) | (Sec) | (%) | Score |
| SEV % | 4.5% | | | | | | | | |
| Control 1 | — | — | 0.7 | — | 20 | — | 1.3 | — | — |
| (Sucrose) | | | | | | | | | |
| Control 2 | [symbol] | — | 1.8 | — | 45 | — | 3.8 | — | 3.3 |
| 1 | [symbol] | Allulose - 3.5% | 1.5 | 17 | 35 | 22 | 3.3 | 13 | 3.0 |
| 2 | 55 | Erythritol - 3.5% | 1.4 | 22 | 30 | 33 | 3.4 | 11 | 1.0 |
| 3 | 45 | Tagatose - 3.5% | 1.7 | [symbol] | 35 | 22 | 3.4 | 11 | 2.7 |
| 4 | [symbol] | Allulose - 1% | 1.7 | [symbol] | 35 | 27 | 3.2 | 16 | 2.7 |
| 5 | [symbol] | Erythritol -1% | 1.7 | [symbol] | 35 | 22 | 3.4 | 11 | 1.8 |
| 6 | [symbol] | Tagatose-1% | 1. [symbol] | 11 | 35 | 22 | 3.3 | 13 | 2.2 |
| SEV % | 6.5% | | | | | | | | |
| Control 3 | — | — | 0.6 | — | 30 | — | 1.1 | — | — |
| (Sucrose) | | | | | | | | | |
| Control 4 | 3 [symbol] | — | 2.1 | — | 40 | — | 3.6 | — | 2.5 |
| 7 | 3 [symbol] | Allulose - 3.5% | 1.9 | 9.52 | 35 | 12.5 | 3.4 | 5.56 | 2. [symbol] |
| 8 | 30 | Erythritol - 3.5% | 1.7 | 19.05 | 30 | 25 | 3.4 | 5.56 | 3.4 |
| 9 | 25 | Tagatose - 3.5% | 1.4 | 33.33 | 35 | 12.5 | 3.1 | 13.89 | 1.5 |

[symbol]

indicates data missing or illegible when filed

Example 6: Flavor Blends Comprising Brazzein in Water-Based Beverages (Citric Acid, pH 3.2)

The sensory profile of a flavor blend comprising brazzein alone was compared with the sensory profiles of flavor blends comprising brazzein combined with allulose, erythritol, or tagatose when dissolved in a water-based beverage comprising 0.07% citric acid at pH4. Sensory profiles were characterized by duration to onset of sweetness, duration of lingering sweet aftertaste, duration to reach maximum sweetness intensity, and average ranked preference score, which were measured as described in Example 5.

As shown in Table 5, brazzein combined with allulose, erythritol, or tagatose in equisweet flavor blends dissolved in the water-based beverage had reduced duration to onset of sweetness, reduced duration of lingering sweet aftertaste, reduced duration to reach maximum sweetness intensity, and/or lower average ranked preference score. In sum, the sensory profile of flavor blends comprising brazzein combined with these bulk sweeteners more closely resembled the sensory profile of sucrose than did the sensory profile of the flavor blend that comprised brazzein alone.

TABLE 5
Sensory Profile of Water-Based Beverages Comprising Flavor Blends

| Flavor | | Bulk | Onset of | | Lingering Sweet | | Reach Max. | | Average |
|---|---|---|---|---|---|---|---|---|---|
| Blend | Brazzein | Sweetener - | Sweetness | | Aftertaste | | Sweetness Intensity | | Ranked |
| Sample | Conc. | Conc. | Duration | Reduction | Duration | Reduction | Duration | Reduction | Preference |
| No. | (ppm) | (%) | (Sec) | (%) | (Sec) | (%) | (Sec) | (%) | Score |
| SEV % | 6.5% | | | | | | | | |
| Control 1 | — | — | 0.7 | — | 25 | — | 0.7 | — | — |
| (Sucrose) | | | | | | | | | |
| Control 2 | 85 | — | 1.5 | — | 40 | — | 3. [symbol] | — | 3.0 |
| 1 | 75 | Allulose - 3.5% | 1.4 | 22 | 35 | 13 | 3. [symbol] | 8 | 2.6 |
| 2 | 75 | Erythritol - 3.5% | 1.4 | 22 | 3 [symbol] | 13 | 3.2 | 11 | 1.8 |
| 3 | [symbol] | Tagatose - 3.5% | 1.4 | 2 [symbol] | 35 | 13 | 3. [symbol] | 8 | [symbol] |
| 4 | 65 | Allulose - 2% | 1.6 | 11 | 30 | 25 | 3.1 | 14 | 2.9 |
| 5 | 75 | Erythritol - 2% | 1.6 | 11 | 35 | 13 | 3.1 | 14 | 1.9 |
| 6 | 70 | Tagatose - 2% | 1.5 | 17 | 30 | 25 | 3.1 | 14 | 2.3 |
| 7 | 70 | Allulose - 1% | 1.5 | 17 | 30 | 25 | 3.2 | 11 | 1.9 |
| 8 | 8 [symbol] | Erythritol - 1% | 1.5 | 17 | 3 [symbol] | 25 | 3.5 | 3 | 2. [symbol] |
| 9 | 75 | Tagatose - 1% | 1.5 | 17 | 25 | 38 | 3. [symbol] | — | 2.1 |
| SEV | 10% | | | | | | | | |
| Control 3 | — | — | 0.7 | — | 30 | — | 1.3 | — | — |
| (Sucrose) | | | | | | | | | |
| Control 4 | 150 | — | 1.7 | — | 45 | — | 2.9 | — | 3.0 |
| 10 | 150 | Allulose - 3.5% | 1.7 | — | 35 | 22 | 2.7 | 7 | 2.7 |
| 11 | 140 | Erythritol - 3.5% | 1.6 | [symbol] | 35 | 22 | 2.7 | 7 | 2.0 |
| 12 | 120 | Tagatose - 3.5% | 1.5 | 12 | 35 | 22 | 2.8 | 3 | 2.3 |

[symbol]

indicates data missing or illegible when filed

### Example 7: Flavor Blends Comprising Brazzein in Protein Beverages (Dairy Protein)

The sensory profile of a flavor blend comprising brazzein alone was compared with the sensory profiles of flavor blends comprising brazzein combined with allulose, erythritol, or tagatose when dissolved in a dairy protein beverage (skim milk or whole milk). Sensory profiles were characterized by duration to onset of sweetness, duration of lingering sweet aftertaste, duration to reach maximum sweetness intensity, and average ranked preference score, which were measured as described in Example 5.

As shown in Table 6, brazzein combined with allulose, erythritol, or tagatose in equisweet flavor blends dissolved in the dairy protein beverage had reduced duration to onset of sweetness, reduced duration of lingering sweet aftertaste, reduced duration to reach maximum sweetness intensity, and/or lower average ranked preference score. In sum, the sensory profile of flavor blends comprising brazzein combined with these bulk sweeteners more closely resembled the sensory profile of sucrose than did the sensory profile of the flavor blend that comprised brazzein alone.

TABLE 6
Sensory Profile of Dairy Protein Beverages Comprising Flavor Blends

| Flavor | | Bulk | Onset of | | Lingering Sweet | | Reach Max. | | Average |
|---|---|---|---|---|---|---|---|---|---|
| Blend | Brazzein - | Sweetener | Sweetness | | Aftertaste | | Sweetness Intensity | | Ranked |
| Sample | Conc. | Conc. | Duration | Reduction | Duration | Reduction | Duration | Reduction | Preference |
| No. | (ppm) | (%) | (Sec) | (%) | (Sec) | (%) | (Sec) | (%) | Score |
| SEV % | 6.5% - Skim Milk (<0.5% fat) | | | | | | | | |
| Control 1 | 130 | — | 1.8 | — | 45 | — | 4.4 | — | 3.0 |
| 1 | 100 | Allulose - 3.5% | 1.5 | 17 | 35 | 22 | 3.8 | 14 | 3.3 |
| 2 | 110 | Erythritol - 3.5% | 1. [symbol] | 22 | 35 | 22 | 3.4 | 23 | 2.0 |
| 3 | 110 | Tagatose - 3.5% | 1.3 | 2 [symbol] | 30 | 33 | 3.4 | 23 | 1.7 |
| SEV | 6.5% - Whole Milk (3.5% fat) | | | | | | | | |
| Control 2 | 150 | — | 2.5 | — | 50 | — | 5.0 | — | 3.0 |
| 4 | 150 | Allulose - 1% | 2.3 | [symbol] | 45 | 25 | 5.0 | — | 2.0 |
| 5 | 150 | Erythritol - 1% | 1.9 | 24 | 40 | 33 | 4.6 | 8 | 1.9 |
| 6 | 140 | Tagatose - 1% | 2.3 | [symbol] | 45 | 25 | 5.1 | — | 3.1 |

[symbol]

indicates data missing or illegible when filed

What is claimed is:
1-109. (Cancelled)

110. A flavor blend consisting of brazzein and an additional sweetener/flavor agent, wherein the flavor blend has a desired sensory profile that is different from a sensory profile of a corresponding flavor blend, wherein the corresponding flavor blend is identical to the flavor blend except that it does not comprise the additional sweetener/flavor agent comprised in the flavor blend, or does not comprise the additional sweetener/flavor agent in an amount as comprised in the flavor blend.

111. The flavor blend of claim 110, wherein the desired sensory profile comprises a reduction in duration to onset of sweetness, a reduction in duration of lingering sweet aftertaste, a reduction in duration to reach maximum sweetness intensity, and/or an improvement in average ranked preference score compared to the corresponding flavor blend.

112. The flavor blend of claim 111, wherein the reduction in duration to onset of sweetness, reduction in duration of lingering sweet aftertaste, reduction in duration to reach maximum sweetness intensity, and/or improvement in average ranked preference score is at least about 3%.

113. The flavor blend of claim 110, wherein the flavor blend comprises between 0.001% and 99.99% by mass of brazzein.

114. The flavor blend of claim 113, wherein the flavor blend consists of brazzein at a concentration of between about 0.04% and about 3.1% by mass; and of the additional sweetener/flavor agent at a concentration of between about 96.9% and about 99.96% by mass.

115. The flavor blend of claim 114, wherein the flavor blend has a SEV of between about 3.5% and about 12%.

116. An ingestible composition comprising the flavor blend of claim 110.

117. The ingestible composition of claim 116, wherein the ingestible composition comprises the flavor blend in an amount between 0.001% and 100% by mass.

118. The ingestible composition of claim 116, wherein the ingestible composition is a food product selected from the group consisting of a dairy product, a substitute dairy product, a beverage, and a protein beverage.

119. The ingestible composition of claim 118, wherein the beverage is a substitute dairy protein beverage comprising a recombinant milk protein selected from the group consisting of recombinant α-lactalbumin, recombinant β-lactoglobulin, recombinant lactotransferrin, recombinant lactoferricin, recombinant serum albumin protein, recombinant lactoperoxidase protein, and/or recombinant glycomacropeptide, recombinant β-casein, recombinant γ-casein, recombinant κ-casein, recombinant α-S1-casein, and recombinant α-S2-casein.

120. The ingestible composition of claim 116, comprising between about 15 ppm and about 160 ppm of brazzein, and between about 0.5% and about 4% by mass of one or more bulk sweeteners.

121. The ingestible composition of claim 116, having a SEV of between about 3.5% and about 12%.

122. The ingestible composition of claim 116, wherein the ingestible composition is essentially free of any sweetener/flavor agent other than the brazzein and the additional sweetener/flavor agent comprised in the flavor blend.

123. The ingestible composition of claim 116, having a reduced calorie content and/or a reduced glycemic index compared to a corresponding ingestible composition that is identical to the ingestible composition and has the same SEV as the ingestible composition except that the corresponding ingestible composition comprises a sugar (e.g., sucrose, glucose, lactose) rather than the flavor blend.

124. A method for producing a flavor blend of claim 1, comprising:
combining an amount of brazzein with an amount of the additional sweetener/flavor agent,
wherein the amount of brazzein and the amount of the additional sweetener/flavor agent are chosen to provide a SEV for the flavor blend of between about 3.5% and about 12%,
wherein the amount of brazzein is between about 0.04% and about 3.1% by mass and the amount of the additional sweetener/flavor agent is between about 96.9% and about 99.96% by mass,
wherein the amount of the flavor blend is chosen to provide for a final concentration in an ingestible composition of between about 15 ppm and about 160 ppm of the brazzein comprised in the flavor blend, and between about 0.5% and about 4% by mass of the additional sweetener/flavor agent comprised in the flavor blend, and
wherein the ingestible composition is essentially free of any sweetener/flavor agent other than the brazzein and the additional sweetener/flavor agent comprised in the flavor blend.

125. The method of claim 124, wherein the ingestible composition is a dairy protein beverage comprising a recombinant milk protein selected from the group consisting of recombinant α-lactalbumin, recombinant β-lactoglobulin, recombinant lactotransferrin, recombinant lactoferricin, recombinant serum albumin protein, recombinant lactoperoxidase protein, and/or recombinant glycomacropeptide, recombinant β-casein, recombinant γ-casein, recombinant κ-casein, recombinant α-S1-casein, and/or recombinant α-S2-casein.

126. The method of claim 124, wherein the ingestible composition comprises a reduced calorie content and/or a reduced glycemic index compared to a corresponding ingestible composition that is identical to the ingestible composition and has the same SEV as the ingestible composition except that the corresponding ingestible composition comprises a sugar (e.g., sucrose, glucose, lactose) rather than the flavor blend.


SEQUENCE LISTING (3 sequences)

SEQ ID NO: 1 - protein, 54 aa, unidentified
  MOD_RES 1: note = pyroglutamic acid
XDKCKKVYENYPVSKCQLANQCNYDCKLDKHARSGECFYDEKRNLQCICDYCEY

SEQ ID NO: 2 - protein, 53 aa, unidentified
DKCKKVYENYPVSKCQLANQCNYDCKLDKHARSGECFYDEKRNLQCICDYCEY

SEQ ID NO: 3 - protein, 54 aa, unidentified
QDKCKKVYENYPVSKCQLANQCNYDCKLDKHARSGECFYDEKRNLQCICDYCEY